(19) United States
(12) Patent Application Publication
(10) Pub. No.: US 2025/0080301 A1
(43) Pub. Date: Mar. 6, 2025

(54) METHODS, COMMUNICATIONS DEVICES, AND INFRASTRUCTURE EQUIPMENT

(71) Applicant: Sony Group Corporation, Tokyo (JP)

(72) Inventors: Shin Horng WONG, Basingstoke (GB); Martin Warwick BEALE, Basingstoke (GB); Yassin Aden AWAD, Basingstoke (GB)

(73) Assignee: Sony Group Corporation, Tokyo (JP)

(21) Appl. No.: 18/580,617

(22) PCT Filed: Jul. 4, 2022
(86) PCT No.: PCT/EP2022/068417

§ 371 Date: Jan. 19, 2024

(30) Foreign Application Priority Data
Jul. 30, 2021 (EP) 21188964.7

(51) Int. Cl. H04L 5/00; H04W 72/231

(52) U.S. Cl. CPC H04L 5/0055; H04W 72/231

(57) ABSTRACT

A method of operating a communications device to receive data from a wireless communications network is provided. The method comprises receiving a plurality of downlink transmissions in physical downlink shared channel resources of a wireless access interface provided by the wireless communications network. Each downlink transmission is a transmission of a data unit transmitted according to a different Hybrid Automatic Repeat Request, HARQ, type process. The method comprises determining that an uplink transmission of the HARQ-ACKs, which is scheduled in uplink resources of the wireless access interface, is cancelled and cannot be transmitted in the scheduled uplink resources and receiving a trigger from the wireless communications network to transmit the cancelled HARQ-ACKs in subsequently scheduled uplink resources by selecting one of a plurality of configured HARQ-ACK codebooks to transmit the cancelled HARQ ACKs, wherein the configured HARQ-ACK codebook is selected based on one or more conditions.

### BACKGROUND

### Field of Disclosure

The present disclosure relates to communications devices, infrastructure equipment and methods for the reception of data by a communications device in a wireless communications network. The present disclosure claims the Paris convention priority of European patent application number EP21188964.7 filed 30 Jul. 2021 the contents of which are incorporated by reference in its entirety.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Latest generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Future wireless communications networks will be expected to routinely and efficiently support communications with an ever-increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for future wireless communications networks, for example those which may be referred to as 5G or new radio (NR) systems/new radio access technology (RAT) systems, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. The increasing use of different types of network infrastructure equipment and terminal devices associated with different traffic profiles give rise to new challenges for efficiently handling communications in wireless communications systems that need to be addressed.

### SUMMARY OF THE DISCLOSURE

The present disclosure can help address or mitigate at least some of the issues discussed above.

Embodiments of the present technique can provide a method of operating a communications device to receive data from a wireless communications network. The method comprises receiving a plurality of downlink transmissions in physical downlink shared channel resources of a wireless access interface provided by the wireless communications network. Each downlink transmission is a transmission of a data unit transmitted according to a different Hybrid Automatic Repeat Request, HARQ, type process.

The method comprises determining a HARQ acknowledgement or negative acknowledgement, HARQ-ACK, for each of the plurality of received downlink transmissions in accordance with whether the data unit for the HARQ type process was correctly received or not. The method comprises determining for each of the different HARQ-type processes for each of the plurality of received of downlink transmissions of the data units, the HARQ-ACKs to be transmitted for the received downlink data units. The method comprises determining that an uplink transmission of the HARQ-ACKs, which is scheduled in uplink resources of the wireless access interface, is cancelled and cannot be transmitted in the scheduled uplink resource. The method comprises receiving a trigger from the wireless communications network to transmit the cancelled HARQ-ACKs in subsequently scheduled uplink resource. The method comprises, in response to the trigger, selecting, by the communications device one of a plurality of configured HARQ-ACK codebooks to transmit the cancelled HARQ ACKs, wherein the configured HARQ-ACK codebook is selected based on one or more conditions.

Embodiments can provide an increased communications efficiency in respect of retransmitting HARQ-ACKs in a wireless communications network. In particular, embodiments can reduce an overhead for HARQ-ACK retransmissions, without unduly increasing a size of downlink control information which can be used to schedule the retransmission of the cancelled HARQ-ACKs and without unduly restricting a number of HARQ-ACK codebooks which can be selected to retransmit the cancelled HARQ-ACKs.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 schematically represents multiple HARQ-ACKs on a grid of communications resources;

FIG. 5 schematically represents PUCCH Resource Indicators for multiple HARQ-ACKs on a grid of communications resources;

FIG. 6 schematically represents sub-slot based PUCCH on a grid of communications resources;

FIG. 7 schematically represents HARQ-ACK for multiple SPS PDSCHs on a grid of communications resources;

FIG. 8 schematically represents HARQ-ACK codebook selection based on cancelled HARQ Process Numbers, HPNs, on a grid of communications resources according to example embodiments;

FIG. 9 schematically represents HARQ-ACK codebook selection based on Component Carriers, CCs, containing cancelled HPNs on a grid of communications resources according to example embodiments;

FIG. 10 schematically represents selecting a HARQ-ACK codebook with the most cancelled HARQ-ACK corresponding to later PDSCHs on a grid of communications resources according to example embodiments;

FIG. 11 schematically represents selecting a HARQ-ACK codebook with the most cancelled HARQ-ACK corresponding to earlier PDSCHs on a grid of communications resources according to example embodiments;

FIG. 12 schematically represents selecting a HARQ-ACK codebook with the most cancelled HARQ-ACK corresponding to PDSCHs within T_{PDSCH} on a grid of communications resources according to example embodiments;

FIG. 13 schematically represents selecting a HARQ-ACK codebook with the most cancelled High Priority, HP, HARQ-ACKs on a grid of communications resources according to example embodiments;

FIG. 14 schematically represents a DCI with a 1-shot trigger which also schedules a PDSCH on a grid of communications resources according to example embodiments;

FIG. 15 schematically represents non-cancelled HARQ-ACKs and cancelled HARQ-ACKs scheduled in the same PUCCH on a grid of communications resources according to example embodiments.

### DETAILED DESCRIPTION OF THE EMBODIMENTS

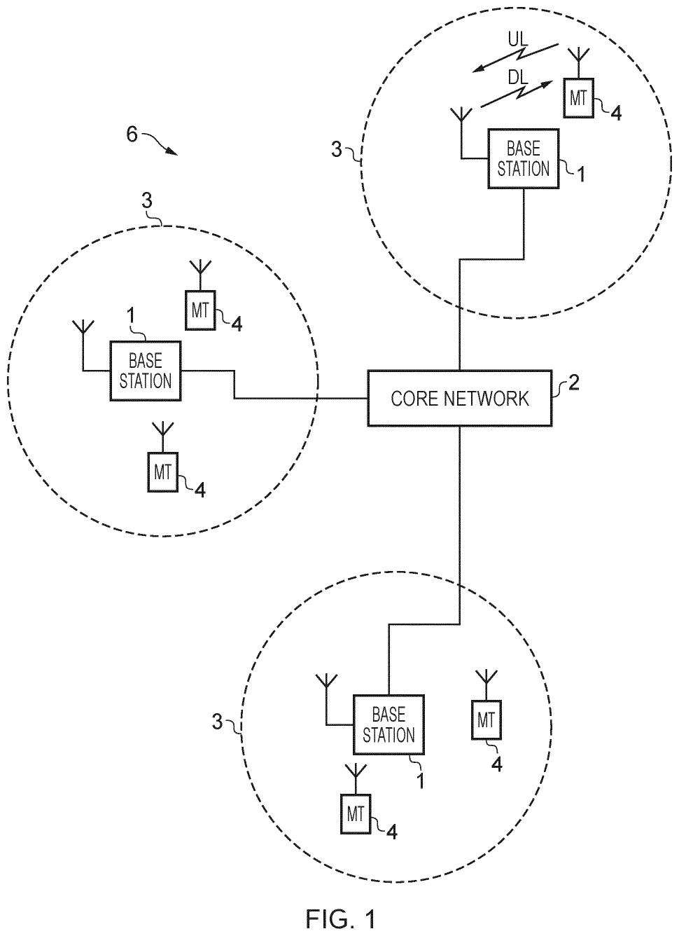

Long Term Evolution Advanced Radio Access Technology (4G) FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP® body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink. Data is transmitted from communications devices 4 to the base stations 1 via a radio uplink. The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

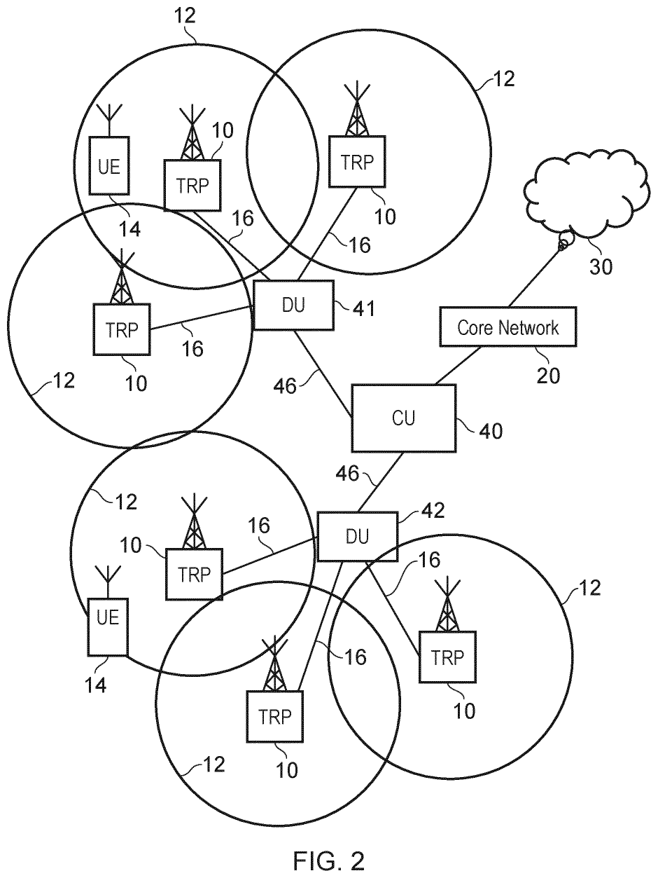

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated that the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a central unit/controlling node 40 and/or a TRP 10 of the kind shown in FIG. 2 which is adapted to provide functionality in accordance with the principles described herein.

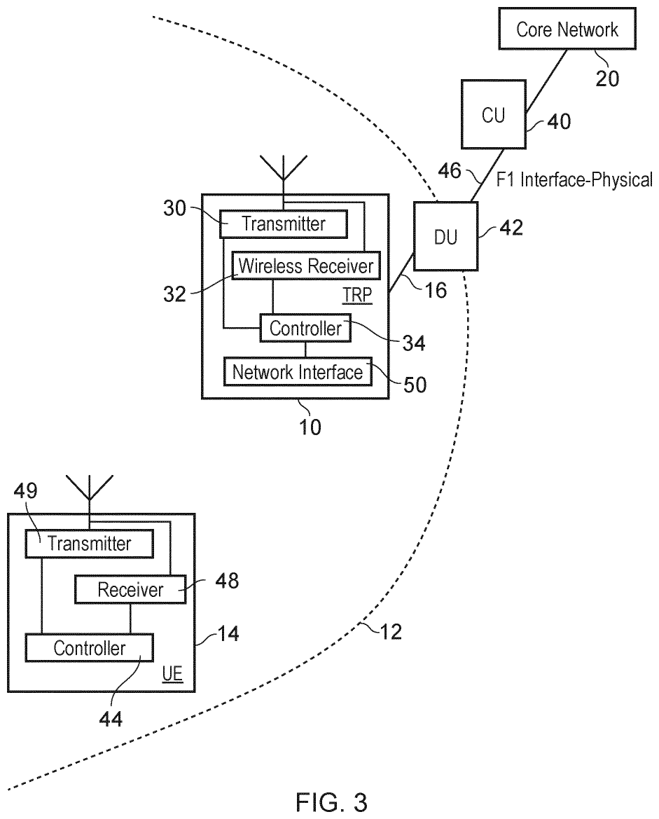

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, a communications device (represented by UE 14 in this example) is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 may include radio frequency filters and amplifiers as well as signal processing components and devices in order to transmit and receive radio signals in accordance for example with the 5G/NR standard. The controllers 34, 44 may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

eURLLC and eMBB

As suggested above, systems incorporating NR technology are expected to support different services (or types of services), which may be characterised by different requirements for latency, data rate and/or reliability. For example, Enhanced Mobile Broadband (eMBB) services are characterised by high capacity with a requirement to support up to 20 Gb/s, with moderate latency and reliability requirements (e.g. 99% to 99.9%). The requirements for Ultra Reliable and Low Latency Communications (URLLC) services on the other hand are for one transmission of a 32 byte packet to be transmitted from the radio protocol layer 2/3 SDU ingress point to the radio protocol layer 2/3 SDU egress point of the radio interface within 1 ms with a reliability of 1-10⁻⁵ (99.999%) or higher (99.9999%) [2].

Massive Machine Type Communications (mMTC) is another example of a service which may be supported by NR-based communications networks. In addition, systems may be expected to support further enhancements related to Industrial Internet of Things (IIoT) in order to support services with new requirements of high availability, high reliability, low latency, and in some cases, high-accuracy positioning.

Enhanced URLLC (eURLLC) [3] specifies features that require high reliability and low latency, such as factory automation, transport industry, electrical power distribution, etc. in a 5G system. eURLLC is further enhanced as IIoT-URLLC [4], for which one of the objectives is to enhance acknowledgement signalling (HARQ-ACK signalling) for downlink transmissions (for example, PDSCH).

### PDSCH HARQ-ACK/NACK Signalling

Embodiments of the disclosure relate to a communications device and methods of operating a communications device in a wireless communications network for handling HARQ (Hybrid Automatic Repeat Request) feedback in respect of downlink transmissions in physical downlink shared channel (PDSCH) resources of a wireless access interface provided by the wireless communications network.

As will be appreciated, HARQ feedback is transmitted by a communications device (such as a UE) to an infrastructure equipment (such as a gNB) in respect of a scheduled PDSCH to inform the infrastructure equipment whether or not the communications device has successfully decoded the corresponding PDSCH or not. Each PDSCH may be transmitted according to a different HARQ process which may be assigned a particular HARQ Process Number (HPN) to identify the HARQ process for that PDSCH. The HPN number may be assigned by infrastructure equipment in the wireless communications network, such as a gNB. Each HARQ process involves transmitting a HARQ acknowledgment (i.e. an ACK) or a HARQ negative acknowledgment (i.e. a NACK) depending on whether the PDSCH transmitted according to that HARQ process was successfully received/decoded. For example, if the PDSCH was successfully received/decoded, the receiving communications device will send a HARQ acknowledgment (i.e. an ACK), and if the transmission was not successfully received the communications device will send a HARQ negative acknowledgment (i.e. a NACK).

It will be appreciated by one skilled in the art that references to “HARQ-ACK” can represent either an “ACK” or a “NACK”, and is used when it is not necessary to distinguish between an “ACK” and a “NACK”.

For scheduled transmission of downlink data from an infrastructure equipment to a communications device in a wireless communications network, it is common for the infrastructure equipment to first send control signalling, e.g. on a downlink control channel (such as a PDCCH—Physical Downlink Control Channel), comprising downlink control information (DCI) which indicates (grants) downlink resources that are to be used to transmit the data, e.g. on a downlink shared channel (such as a PDSCH).

From this, the communications device can determine uplink resources to use to send uplink control information (UCI) comprising a ACK or NACK in respect of the data, e.g. on an uplink control channel (such as a PUCCH), although it may also be on an uplink shared channel (such as a PUSCH). The communications device then seeks to receive the data on the indicated resources on the PDSCH. If the communications device successfully decodes the data, then the communications device transmits UCI on the determined uplink resources comprising an ACK. If the communications device does not successfully decode the data, the communications device transmits UCI on the determined uplink resources comprising a NACK. This allows the infrastructure equipment to determine if it should schedule a retransmission of the data.

So as to provide some particular examples, certain embodiments of the disclosure will be described herein in the context of HARQ-ACK retransmissions in respect of downlink transmissions of URLLC data and using terminology, for example in respect of channel names such as PUCCH and PDSCH and signalling names, such as DCI and UCI, which are typically used in connection with current 3GPP wireless communications networks. However, it will be appreciated this is only for convenience, and in general the approaches discussed herein are applicable for other service types and in wireless communications networks which use different terminology. Thus, references herein to PUCCH should, unless the context demands otherwise, be read as referring to a physical uplink control channel generally, and not specifically to a particular format of physical uplink control channel, and so on for other channels and terminology that may be referred to herein.

As will be appreciated, resources of a wireless access interface comprise a grid of resources (i.e. a radio frame structure) spanning frequency and time. The frequency dimension is divided into sub-carriers and the time dimension is divided into symbols that are grouped into slots.

### Dynamic Grant PDSCH

As explained above, embodiments are related to the handling of HARQ feedback in respect of PDSCH resources of a wireless access interface provided by the wireless communications network. One way of providing PDSCH resources for downlink transmissions is by dynamic grant PDSCH. In a Dynamic Grant Physical Downlink Shared Channel (DG-PDSCH), a PDSCH resource is dynamically indicated by a gNB using a DL Grant carried by Downlink Control Information (DCI) in a Physical Downlink Control Channel (PDCCH).

A PDSCH is transmitted using HARQ transmission, where for a PDSCH ending in slot n, the corresponding Physical Uplink Control Channel (PUCCH) carrying the HARQ-ACK is transmitted in slot n+K₁. In Dynamic Grant PDSCH, the value of K₁ is indicated in field “PDSCH-to-HARQ_feedback timing indicator” of the DL Grant (carried by DCI Format 1_0, DCI Format 1_1 or DCI Format 1_2). Multiple, different PDSCHs can point to the same slot for transmission of their respective HARQ-ACKs. The HARQ-ACKs to be transmitted in the same slot are multiplexed into a single PUCCH. Hence, a PUCCH can contain multiple HARQ-ACKs for multiple PDSCHs.

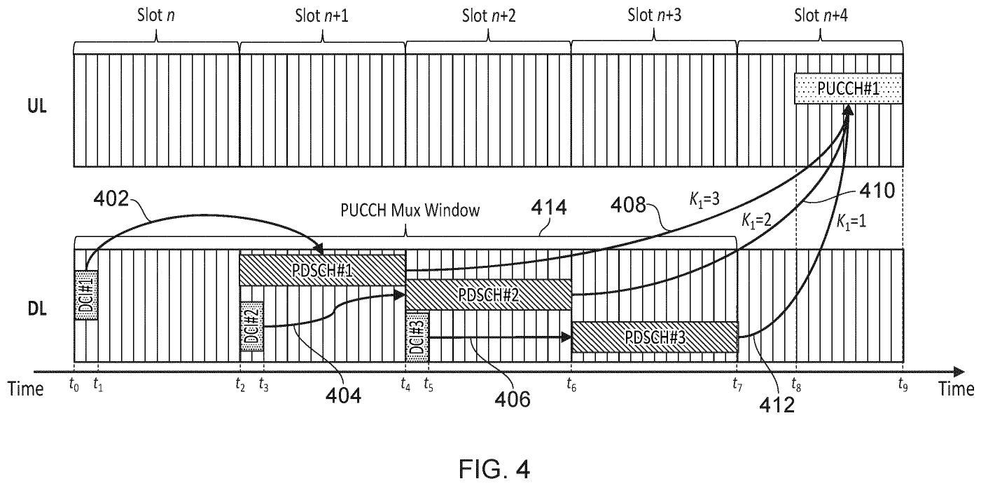

An example of multiplexing multiple HARQ-ACKs is schematically shown on a radio communications grid in FIG. 4. FIG. 4 schematically shows an uplink radio resource grid (top half of FIG. 4) and a downlink radio resource grid (bottom half of FIG. 4) representing radio resources in time (horizontal axis) and frequency (vertical axis). FIG. 4 schematically shows radio resources used by a communications device (such as communications device 4 or 14) in an example scenario during a period spanning five slots. In FIG. 4, the five slot period spans slots n to n+4. In slot n, the communications device receives a first DCI (DCI #1). As represented by arrow 402, DCI #1 indicates an allocation of radio resources on a first PDSCH (PDSCH #1) in slot n+1 with a PDSCH-to-HARQ_feedback timing indicator value of K₁=3 and a “PUCCH Resource Indicator” (PRI) field indicating resources in slot n+4 (PUCCH #1). In slot n+1, the communications device receives a second DCI (DCI #2). As represented by arrow 404, DCI #2 indicates an allocation of radio resources on a second PDSCH (PDSCH #2) in slot n+2 with a PDSCH-to-HARQ_feedback timing indicator value of K₁=2 and a PRI field indicating the same resources in slot n+4 as for DCI #1 (i.e. PUCCH #1). In slot n+2, the communications device receives a third DCI (DCI #3). As represented by arrow 406, DCI #3 indicates an allocation of radio resources on a third PDSCH (PDSCH #3) in slot n+3 with a PDSCH-to-HARQ_feedback timing indicator value of K₁=1 and a PRI field indicating the same resources in slot n+4 as for DCI #1 and DCI #2 (i.e. PUCCH #1). Thus, as represented by respective arrows 408, 410, 412, the HARQ-ACKs for each of the three downlink transmissions on the physical downlink shared channel are scheduled to be transmitted by the communications device in slot n+4 and so can be transmitted in a multiplexed manner. To support this multiplexed HARQ-ACK function, a Multiplexing Window may be defined. The Multiplexing Window is a time window indicating how many PDSCHs can have their associated HARQ-ACK signalling multiplexed in PUCCH in a single slot and may depend on the range of K₁ values. In the example in FIG. 4, the PUCCH Multiplexing Window 414 is assumed to be from Slot n to Slot n+3, which means the max K₁ value that can be used in this period is 4.

In the example represented in FIG. 4, only one PUCCH is indicated for the communications device in slot n+4 (i.e. PUCCH #1). For wireless communications networks operating in accordance with Release 15 of the 3GPP standards, only one PUCCH per slot is allowed to carry HARQ-ACKs for the same communications device even if PUCCHs in the same slot do not overlap in time. For example, if a PRI field in two different DL grants indicate two different PUCCH resources in the same slot, the communications device will follow the PRI indicated in the last PDSCH in the PUCCH Multiplexing Window since the communications device only knows the total number of HARQ-ACK bits after the last PDSCH is received.

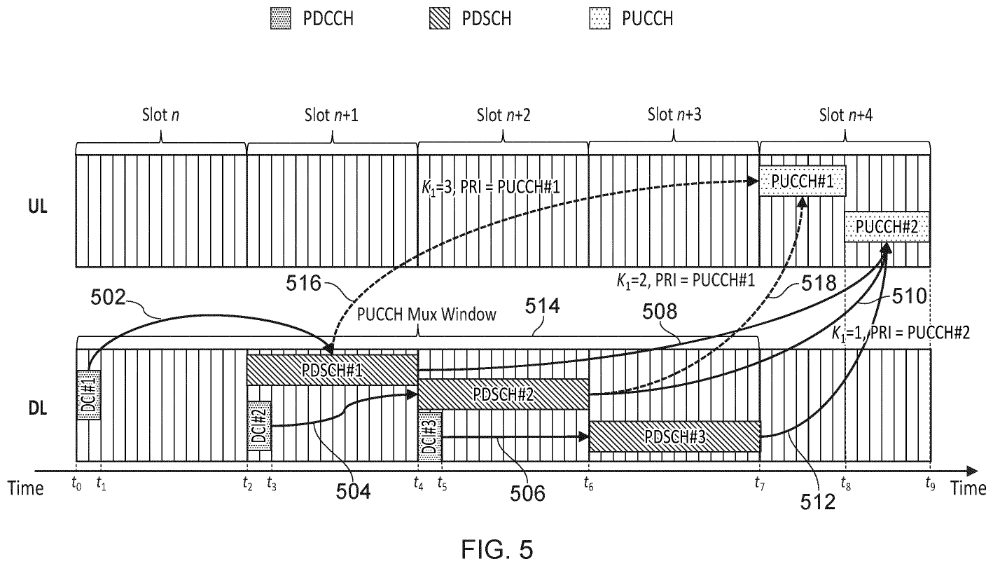

An example of two non-overlapping PUCCH resources being scheduled in the same slot is illustrated in FIG. 5. FIG. 5 is similar to, and will be understood from, FIG. 4, but this example schematically shows an uplink radio resource grid (top half of figure) and downlink radio resource grid (bottom half of figure) representing radio resources in time (horizontal axis) and frequency (vertical axis) in a scenario in which two PUCCH resources are indicated in the same slot.

In slot n, the communications device receives a first DCI (DCI #1). As represented by arrow 502, DCI #1 indicates an allocation of radio resources on a first PDSCH (PDSCH #1) in slot n+1 with a PDSCH-to-HARQ_feedback timing indicator value of K₁=3 and a PRI field indicating resources in slot n+4 (PUCCH #1). In slot n+1, the communications device receives a second DCI (DCI #2). As represented by arrow 504, DCI #2 indicates an allocation of radio resources on a second PDSCH (PDSCH #2) in slot n+2 with a PDSCH-to-HARQ_feedback timing indicator value of K₁=2 and a PRI field indicating the same resources in slot n+4 as for DCI #1 (i.e. PUCCH #1). In slot n+2 the communications device receives a third DCI (DCI #3). As represented by arrow 506, DCI #3 indicates an allocation of radio resources on a third PDSCH (PDSCH #3) in slot n+3 with a PDSCH-to-HARQ_feedback timing indicator value of K₁=1 and a PRI field indicating different resources for PUCCH (i.e. PUCCH #2) in slot n+4 in comparison to the PUCCH resources indicated in DCI #1 and DCI #2 (i.e. PUCCH #1).

Thus, as represented by respective dashed arrows 516 and 518, the HARQ-ACK for each of PDSCH #1 and PDSCH #2 are respectively scheduled to be transmitted by the communications device in slot n+4 using PUCCH #1, and, as represented by arrow 512, the HARQ-ACK for PDSCH #3 is scheduled to be transmitted by the communications device in slot n+4 using PUCCH #2. In this example, PUCCH #1 and PUCCH #2 do not overlap in time. Since DCI #3 schedules the last PDSCH in the Multiplexing Window 514 (i.e. PDSCH #3), the communications device will use PUCCH #2 to carry the HARQ-ACKs for PDSCH #1 (as represented by arrow 508), PDSCH #2 (as represented by arrow 510) and PDSCH #3 (as represented by arrow 512). It will be appreciated that a PUCCH carrying other UCI such as SR (Scheduling Request) can be transmitted separately to a PUCCH carrying HARQ-ACK within the same slot if they do not overlap in time.

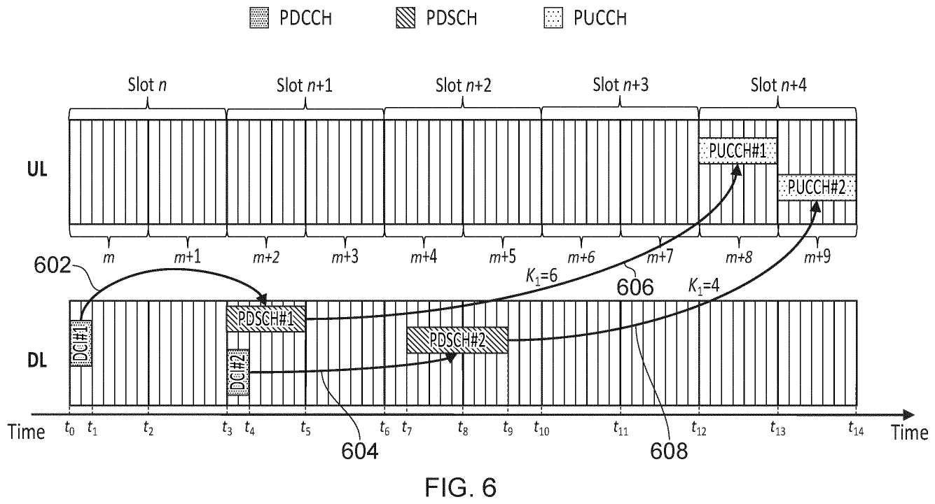

For Release 16 of the 3GPP standards, the possibility of sub-slot operation for HARQ-ACK acknowledgement signalling was introduced. Sub-slot operation for HARQ-ACK allows the timings of HARQ-ACK UCI on PUCCH to be configured with a resolution which is less than one slot (i.e. the HARQ-ACK process operates with sub-slot timing granularity). Sub-slot based PUCCH thus allows more than one PUCCH carrying HARQ-ACKs to be transmitted within a slot. This provides for more opportunities for PUCCH carrying HARQ-ACK in respect of PDSCH transmissions to be transmitted within a slot, thereby potentially helping to reduce the latency of HARQ-ACK. In a sub-slot based PUCCH, the granularity of the K₁ parameter (i.e. the time difference between the end of PDSCH and the start of its corresponding PUCCH) is in units of sub-slot instead of slot, where the sub-slot size can be 2 symbols or 7 symbols. An example of sub-slot HARQ-ACK operation is shown in FIG. 6.

FIG. 6 is similar to, and will be understood from, FIG. 4, but this example schematically shows an uplink radio resource grid (top half of figure) and downlink radio resource grid (bottom half of figure) representing radio resources in time (horizontal axis) and frequency (vertical axis) in a scenario that supports sub-slot operation for HARQ-ACK with a sub-slot size of 7 symbols (i.e. half a slot in this case). Thus FIG. 6 schematically shows radio resources used by a communications device in an example scenario during a period spanning five slots (identified in FIG. 6 as slots n to n+4)/ten sub-slots (identified in FIG. 6 as sub-slots m to m+9). In sub-slot m, the communications device receives a first DCI (DCI #1). As represented by arrow 602, DCI #1 indicates an allocation of radio resources on a first PDSCH (PDSCH #1) in sub-slot m+2 with a PDSCH-to-HARQ_feedback timing indicator value of K₁=6.

Therefore, as represented by arrow 606, the communications device determines PUCCH #1 for transmitting a HARQ-ACK in respect of PDSCH #1 as indicated by the PRI associated with DCI #1 in sub-slot m+8 (since this is the sub-slot which is K₁=6 sub-slots after the sub-slot in which PDSCH #1 ends). In sub-slot m+2, the communications device receives a second DCI (DCI #2). As represented by arrow 604, DCI #2 indicates an allocation of radio resources for a second PDSCH (PDSCH #2) that spans sub-slots m+4 and m+5 with a PDSCH-to-HARQ_feedback timing indicator value of K₁=4. Therefore, as represented by arrow 608, the communications device determines PUCCH #2 to use for transmitting a HARQ-ACK in respect of PDSCH #2 as indicated by the PRI associated with DCI #2 in sub-slot m+9 (since this is the sub-slot which is K₁=4 sub-slots after the sub-slot in which PDSCH #2 ends). In contrast to approaches according to Release 15 of the 3GPP standards specification series, where only one PUCCH carrying HARQ-ACK is allowed in a slot, in a sub-slot based operation, a communications device can transmit two PUCCH carrying HARQ-ACK (i.e. PUCCH #1 and PUCCH #2) in a slot.

### Semi-Persistent Scheduling (SPS)

As explained above, PDSCH resources used for the transmission of a PDSCH can be scheduled by a gNB dynamically in dynamic grant PDSCH. Another way of providing PDSCH resources for downlink transmissions is through the allocation of Semi-Persistent Scheduling (SPS) resources.

Similarly to the use of Configured Grants (CGs) in the uplink, the use of SPS in the downlink reduces latency, particularly for regular and periodic traffic. The gNB is required to explicitly activate and deactivate SPS resources when it determines they may be required. These SPS resources are typically configured via Radio Resource Control (RRC) signalling, and occur periodically where each SPS PDSCH occasion has a pre-configured and fixed duration. This allows the gNB to schedule traffic that has a known periodicity and packet size. The gNB may or may not transmit any PDSCH in any given SPS PDSCH occasion, and so the communications device is required to monitor each SPS PDSCH occasion for a potential PDSCH transmission.

In Release 15 of the 3GPP standards, the communications device can only be configured with one SPS PDSCH and this SPS PDSCH is activated using an activation DCI (Format 1_0 or 1_1) with the Cyclic Redundancy Check (CRC) scrambled with a Configured Scheduling Radio Network Temporary Identifier (CS-RNTI). Once an SPS PDSCH is activated, the communications device will monitor for a potential PDSCH in each SPS PDSCH occasion of the SPS PDSCH configuration without the need for any DL Grant until the SPS PDSCH is deactivated. Deactivation of the SPS PDSCH is indicated via a deactivation DCI scrambled with CS-RNTI. The communications device provides a HARQ-ACK for the deactivation DCI, but no HARQ-ACK is provided for an activation DCI.

Similar to DG-PDSCH, the slot containing the PUCCH resource for HARQ-ACK corresponding to SPS PDSCH is indicated using the K₁ value in the field “PDSCH-to-HARQ_feedback timing indicator” of the activation DCI. Since a dynamic grant is not used for SPS PDSCH, this K₁ value is applied for every SPS PDSCH occasion, and can only be updated after it has been deactivated and re-activated using another activation DCI with a different K₁ value.

Since there is only one SPS PDSCH, PUCCH Format 0 or 1 is used to carry the HARQ-ACK. If the PUCCH collides with a PUCCH carrying HARQ-ACK for a DG-PDSCH, the HARQ-ACK for SPS PDSCH is multiplexed into the PUCCH corresponding to the DG-PDSCH.

In Release 16 of the 3GPP standards, the communications device can be configured with up to eight SPS PDSCHs, where each SPS PDSCH has an SPS Configuration Index that is RRC configured. Each SPS PDSCH is individually activated using a DCI (Format 1_0, 1_1 & 1_2) with the CRC scrambled with CS-RNTI, where the DCI indicates the SPS Configuration Index of the SPS PDSCH to be activated. However, multiple SPS PDSCHs can be deactivated using a single deactivation DCI. Similar to Release 15 of the 3GPP standards, the communications device provides a HARQ-ACK for the deactivation DCI, but does not provide one for the activation DCI.

The slot or sub-slot containing the PUCCH resource for HARQ-ACK corresponding to an SPS PDSCH occasion is determined using the K₁ value indicated in the activation DCI. Since each SPS PDSCH configuration is individually activated, different SPS PDSCH can be indicated with different K₁ values.

Since different K₁ values can be used for different SPS PDSCH configurations, it is possible that the HARQ-ACK for multiple SPS PDSCHs point to the same slot or sub-slot and in such a scenario, these HARQ-ACKs are multiplexed into a single PUCCH. For multiple SPS PDSCH configurations, PUCCH Format 2, 3 & 4 (in addition to PUCCH Format 0 & 1) can be used to carry multiple HARQ-ACKs for SPS PDSCH. Here the HARQ-ACKs in the PUCCH are sorted in ascending order according to the DL slot for each of the SPS PDSCH Configuration Indices and then sorted in ascending order of the SPS PDSCH Configuration Index. It will be appreciated that, since typically the K₁ value is fixed per SPS PDSCH then it is unlikely to have two or more SPS PDSCHs with the same index multiplexed into a PUCCH.

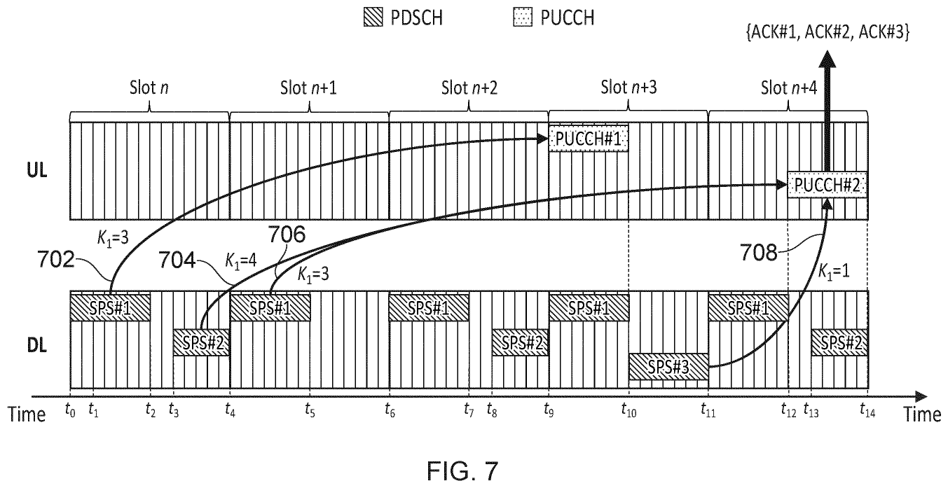

An example of HARQ-ACK transmission for multiple SPS PDSCHs on a grid of communications resources is schematically shown in FIG. 7. In FIG. 7, a communications device is configured with three SPS PDSCHs labelled as SPS #1, SPS #2 and SPS #3. As shown, each of the SPS #1, SPS #2 and SPS #3 have different periodicities which are RRC configured with SPS Configuration Index 1, 2 and 3 respectively. SPS #1, SPS #2 and SPS #3 are activated with K₁=3, K₁=4 and K₁=1 respectively. As such, and as represented by respective arrows 704, 706 and 708, the HARQ-ACKs for SPS #2 in Slot n, SPS #1 in Slot n+1 and SPS #3 in Slot n+3 are transmitted in the same slot, i.e. carried by PUCCH #2, in Slot n+4. PUCCH #2 therefore provides three HARQ-ACKs labelled as {ACK #1, ACK #2, ACK #3} for SPS #1, SPS #2 and SPS #3 respectively according to their SPS PDSCH Configuration Indices. In this example, there is only one unique SPS PDSCH per DL slot that have HARQ-ACK multiplexed into PUCCH #2.

When the PUCCH for SPS PDSCHs collides with PUCCH for DG-PDSCH, the HARQ-ACK for the SPS PDSCH and the DG-PDSCH are multiplexed. In such cases, the HARQ-ACK for the SPS PDSCH is appended after the HARQ-ACK for DG-PDSCH.

### Cancelled HARQ ACKs

A PUCCH or PUSCH carrying HARQ-ACKs for PDSCHs may be cancelled due to for example intra-UE L1 prioritisation when the PUCCH or PUSCH collides with a higher priority PUCCH or PUSCH. A PUCCH or PUSCH transmission may also be cancelled by an UL Cancellation Indicator due to uplink inter-UE prioritisation. For example, if a communications device with a lower priority uplink transmission collides with a higher priority uplink transmission for another communications device, the UL Cancellation Indicator cancels the uplink transmission for the communications device with the lower priority. In Time Division Duplexing (TDD), a PUCCH for SPS PDSCH can also be cancelled if it collides with DL symbols or invalid symbols. A cancelled PUCCH that contains multiple HARQ-ACKs may lead to the retransmission of multiple PDSCHs since the gNB may not be aware of the decoding status of these PDSCHs. This may lead to inefficient resource utilisation. For example, the communications device may have already decoded most of the PDSCHs and yet the HARQ-ACKs for all of the PDSCHs may have to be transmitted again. As a result, as part of Release 17 of the 3GPP standards, it has been agreed to specify a feature to retransmit the cancelled (or dropped) HARQ-ACK. The following two methods have been agreed by 3GPP:
A Dynamic HARQ-ACK Codebook that retransmits cancelled HARQ-ACK, or
Enhancing the Type 3 HARQ-ACK Codebook to reduce its overhead

The dynamic HARQ-ACK Codebook has a dynamic size and is triggered to carry only HARQ-ACK for retransmissions. In other words, the dynamic HARQ-ACK codebook carries only HARQ-ACK which were previously cancelled. This dynamic HARQ-ACK Codebook, which may alternatively be referred to as a Retransmission HARQ-ACK Codebook (ReTx CB), is triggered by a DCI similar to that used for Type 3 HARQ-ACK Codebook.

The Type 3 HARQ-ACK Codebook was introduced for NR-U in Release 16 of the 3GPP standards to trigger a communications device to retransmit HARQ-ACK due to unsuccessful PUCCH/PUSCH HARQ-ACK transmission(s) resulting from LBT (Listen Before Talk) failure. Type 3 HARQ-ACK Codebook is triggered using the 1-bit DCI field “One-shot HARQ-ACK request” (1-shot) in DCI Format 11, which indicates to the communications device to transmit PDSCH HARQ-ACK for all configured HARQ Process Numbers (HPN) across all Component Carriers (CC) regardless of whether the HARQ-ACK had been transmitted previously or failed to transmit due to a failed LBT attempt. Further description of Type 3 HARQ-ACK Codebooks can be found in [5]. As will be appreciated, the number of cancelled HARQ-ACKs requiring retransmission is likely going to be a very small subset of the number of HARQ-ACKs in the Type 3 CB. In other words, the use of Type 3 CB for HARQ-ACK retransmission may result in very high overheads. To address this issue, 3GPP is currently considering methods to reduce the overhead of Type 3 CB by enhancing Type 3 CB to create an enhanced Type 3 HARQ-ACK Codebook (e-Type 3 CB). It has been proposed that the size of the e-Type 3 CB should be restricted, for example, the size of the e-Type 3 CB contains HARQ-ACK for only activated CCs rather than configured CCs [6], a subset of configured CCs [7] or a subset of configured HPN [8].

The number of cancelled HARQ-ACKs changes dynamically but the size of the e-Type 3 CB is semi-statically configured and hence the overhead may still be large. For example, using the method in [6] where e-Type 3 CB contains HARQ-ACKs for only activated CCs, if there are 2 activated CCs and only one of the CCs require retransmission for three HARQ-ACKs, the e-Type 3 CB would still need to feedback 32 HARQ-ACKs (2 CCs×16 HPN), i.e. a 90% overhead. Hence, it has been proposed that the communications device is RRC configured with multiple e-Type 3 CBs with different sizes and the DCI triggering the e-Type 3 CB indicates which of the configured e-Type 3 CBs to use depending on the number of cancelled HARQ-ACKs. A new DCI field may need to be defined for such indication which will increase the size of the DCI which is not desirable for URLLC (that favours compact DCI size). To keep the DCI size small, it has been proposed to use the RNTI of the DCI to indicate which e-Type 3 CB to use [8] but this would limit the number of e-Type 3 CB that can be configured since the number of RNTI that is configured is typically limited, e.g. in [8], it is proposed to use two RNTIs. In another proposal, the DCI that triggers the e-Type 3 CB is not allowed to schedule a PDSCH so that the existing DCI fields used for scheduling the PDSCH, e.g. MCS, TDRA, FDRA, are reused to indicate one of multiple e-Type 3 CBs [7]. This limits the PDSCH scheduling opportunities since the DCI that triggers the e-Type 3 CB or Type 3 CB is a DL Grant.

There is therefore a need for increased efficiency in respect of transmitting, or retransmitting, cancelled HARQ-ACKs. In particular, the problem of reducing overhead for HARQ-ACK retransmissions needs to be addressed.

In view of the above, there is provided a method of operating a communications device to receive data from a wireless communications network. The method comprises receiving a plurality of downlink transmissions in physical downlink shared channel resources of a wireless access interface provided by the wireless communications network. Each downlink transmission is a transmission of a data unit transmitted according to a different Hybrid Automatic Repeat Request, HARQ, type process. The method comprises determining a HARQ acknowledgement or negative acknowledgement, HARQ-ACK, for each of the plurality of received downlink transmissions in accordance with whether the data unit for the HARQ type process was correctly received or not. The method comprises determining for each of the different HARQ-type processes for each of the plurality of received downlink transmissions of the data units, the HARQ-ACKs to be transmitted for the received downlink data units. The method comprises determining that an uplink transmission of the HARQ-ACKs, which is scheduled in uplink resources of the wireless access interface, is cancelled and cannot be transmitted in the scheduled uplink resources. The method comprises receiving a trigger from the wireless communications network to transmit the cancelled HARQ-ACKs in subsequently scheduled uplink resources. The method comprises, in response to the trigger, selecting one of a plurality of configured HARQ-ACK codebooks to transmit the cancelled HARQ ACKs, wherein the configured HARQ-ACK codebook is selected based on one or more conditions.

It will be appreciated that, when a communications device transmits HARQ-ACKs based on a selected codebook, such as a Type 3 based codebook, the communications device will transmit all of the HARQ-ACK configured for the selected codebook, whether or not the indicated HARQ-ACK has been previously transmitted by the communications device or not as will be explained below.

Example embodiments can maintain a DCI size regardless of the number of configured HARQ-ACK Codebooks. For example, the communications device is configured with multiple e-Type 3 CBs with different sizes and upon triggering the e-Type 3 CB using the One-Shot trigger, the communications device will select one of these multiple e-Type 3 CBs based on the condition of the cancelled HARQ-ACKs without the need of further indication or with minimal indication. In some embodiments, the communications device is configured with the plurality of HARQ-ACK codebooks by an infrastructure equipment of the wireless communications network, such as a gNB. For example, the infrastructure equipment may transmit one or more signals including an indication of the plurality of configured HARQ-ACK codebooks for the communications device from which the communications device selects one to transmit the cancelled HARQ-ACKs.

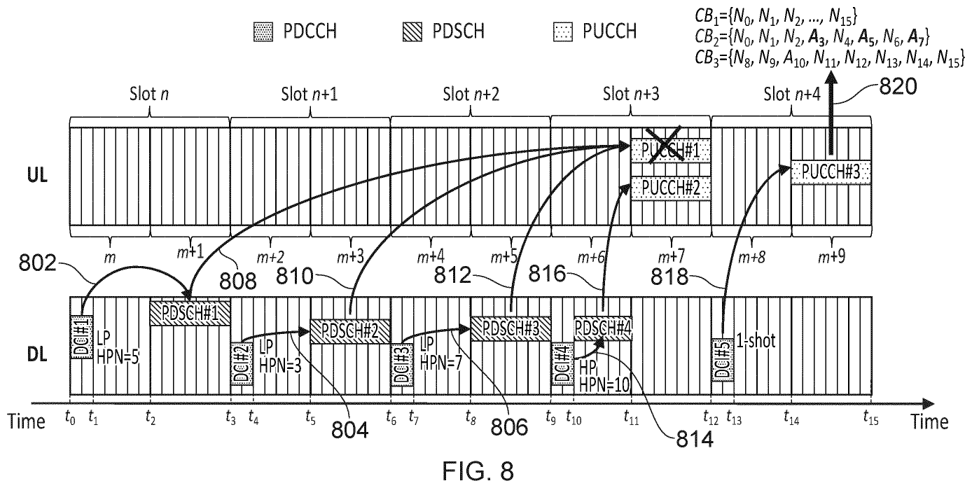

Example embodiments will now be described with reference to FIGS. 8 to 15 below. Each of FIGS. 8 to 15 are explained in the context of dynamic grant PDSCH scenarios which have been explained in detail with reference to FIGS. 4 to 6 above. Therefore, although unnecessary repetition will be avoided, it will be appreciated, for example, that references to a DCI scheduling/indicating a PDSCH, and scheduling/indicating a PUCCH for transmitting a HARQ-ACK in respect of the PDSCH, may be achieved using a K₁ value indication and a PRI field indication in the DCI as explained above. It will furthermore be appreciated that each of the embodiments explained with reference to FIG. 8 to 15 below are also applicable to SPS scenarios as explained with reference to FIG. 7 above.

### Number of Cancelled HARQ-ACKs

In example embodiments, the one or more conditions for selecting a HARQ-ACK codebook include conditions of a number of cancelled HARQ-ACKs. For example, the communications device may select the HARQ-ACK codebook with the highest number of cancelled HARQ-ACKs (N_{HARQ-ACK}) for transmitting the cancelled HARQ-ACKs. The communications device may be provided with a set of X pre-determined thresholds, {T_{HARQ-1}, T_{HARQ-2}, . . . , T_{HARQ-X}} for X configured HARQ-ACK Codebooks {CB₁, CB₂, . . . , CB_{X}}.

In such embodiments, the communications device may select the HARQ-ACK Codebook according to the following example conditions:
Select CB₁, if N_{HARQ-ACK}≤T_{HARQ-1},
Select CB_{Y}, if T_{HARQ-(Y-1)}<N_{HARQ-ACK}≤T_{HARQ-Y},
Select CB_{X}, if N_{HARQ-ACK}≤T_{HARQ-X}

In example embodiments, the set of pre-determined thresholds may be RRC configured.

In example embodiments, the set of pre-determined thresholds is determined by the communications device. In some embodiments, the thresholds correspond to the size of the HARQ-ACK Codebook, i.e. T_{HARQ-Y}=size of CB_{Y} (e.g. T_{HARQ-1}=size of CB₁, T_{HARQ-2}=size of CB₂, etc).

In example embodiments, where the one or more conditions include the number of cancelled HARQ-ACKs, the HARQ-ACK Codebook CB₁ is the new ReTx CB. That is, if N_{HARQ-ACK} is equal to or below a threshold T_{HARQ-1}, the communications device selects the new dynamic ReTx CB, which retransmits only cancelled HARQ-ACKs. If N_{HARQ-ACK}>T_{HARQ-1}, the communications device will use one of the configured e-Type 3 CBs. This recognizes that if N_{HARQ-ACK} is small, then it is more resource efficient to retransmit only cancelled HARQ-ACKs compared to using a semi-static sized HARQ-ACK Codebook that would likely incur large overhead. On the other hand, if N_{HARQ-ACK} is large, then it is more likely that one or more DL Grants had been missed by the communications device especially DL Grants scheduling LP PUCCH (low priority, which is less protected), and in this case using a semi-static sized HARQ-ACK Codebook, like e-Type 3, provides more robustness against missed detection.

### HARQ Process Number (HPN)

In example embodiments, the one or more conditions for selecting a HARQ-ACK codebook include conditions on a HARQ Process Number (HPN) of the cancelled HARQ-ACKs. For example, the HARQ-ACK codebooks, e.g. e-Type 3 CBs, may be configured to contain a subset of HPNs and the communications device may select the HARQ-ACK codebook with the most HPNs within its configured set of HPNs that matches the HPN of the cancelled HARQ-ACKs. In the case where two HARQ-ACK codebooks have the same number of matching HPNs, the communications device may select the HARQ-ACK codebook that has the smallest size.

An example of HARQ-ACK codebook selection based on cancelled HPNs is schematically represented on a grid of communications resources in FIG. 8. As shown in FIG. 8, a communications device may be configured with three e-Type 3 CBs, namely, CB₁, CB₂ and CB₃ such that CB₁ contains all the HPN whilst CB₂ contains the lower half of HPN and CB₃ contains the upper half of the HPN, i.e. the HPN set configuration for each of the CBs are as follows:
CB₁={0, 1, 2, 3, 4, 5, 6, 7, 8, 9, 10, 11, 12, 13, 14, 15}
CB₂={0, 1, 2, 3, 4, 5, 6, 7}
CB₃={8, 9, 10, 11, 12, 13, 14, 15}

It will be appreciated that the configuration of HARQ-ACK codebooks in FIG. 8 is one example and other configurations in other example embodiments are possible. For example, a larger or smaller number of HARQ-ACK codebooks may be configured for the communications device or the contents of the HARQ-ACK codebooks may be different. For example, one HARQ-ACK Codebook may carry odd numbered HPN and another may carry even numbered HPN.

In FIG. 8, DCI #1, DCI #2 and DCI #3 respectively schedule PDSCH #1, PDSCH #2 and PDSCH #3 as indicated by respective arrows 802, 804 and 806. DCI #1, DCI #2 and DCI #3 each indicate PUCCH #1 in sub-slot m+7 for transmitting HARQ-ACK for each of PDSCH #1, PDSCH #2 and PDSCH #3 as indicated by respective arrows 808, 810 and 812. For the example embodiment described with respect to FIG. 8, PUCCH #1 has a Low L1 priority (LP) and may therefore be referred to as “LP PUCCH #1”.

PDSCH #1, PDSCH #2 and PDSCH #3 are assigned with HPN 5, 3 and 7 respectively. As shown by arrow 814, DCI #4 schedules PDSCH #4 which is assigned HPN 10. DCI #4 indicates PUCCH #2 in sub-slot m+7 for transmitting HARQ-ACK for PDSCH #4 as shown by arrow 816. PUCCH #2 has a High L1 Priority (HP) and may therefore be referred to as “HP PUCCH #2”.

As shown in FIG. 8, PUCCH #1 and PUCCH #2 overlap in time. In other words, PUCCH #1 collides with PUCCH #2 and vice versa. Since PUCCH #2 has higher L1 priority than PUCCH #1, PUCCH #1 is dropped. In other words, the HARQ-ACKs for PDSCH #1, PDSCH #2 and PDSCH #3 are cancelled. At time t₁₂, DCI #5 contains a 1-shot trigger for an e-Type 3 CB. As represented by arrow 818, DCI #5 indicates PUCCH #3 in sub-slot m+9 for retransmitting cancelled HARQ-ACKs. In response, the communications device selects one of the three configured HARQ-ACK codebooks for retransmitting the cancelled HARQ-ACKs. The HPN set configured for CB₁ and CB₂ contain all the cancelled HPNs, i.e. HPN 3, 5 and 7. In accordance with example embodiments, since CB₂ has a smaller size than CB₁, the communications device selects CB₂ to carry the cancelled HARQ-ACKs. As shown by arrow 820, the communications device then retransmits the cancelled HARQ-ACKs for HPN 3, 5 and 7, and also transmits the other HARQ-ACK/NACKs indicated by CB₂. For example, the communications device also transmits NACKs for HPNs 0, 1, 2, 4 and 6 since the communications device did not receive any PDSCH for those HPNs.

### Component Carriers

In example embodiments, the one or more conditions for selecting the HARQ-ACK codebooks includes conditions on the Component Carriers (CC) containing cancelled HARQ-ACKs. The communications device is configured with HARQ-ACK codebooks, e.g. e-Type 3 CBs, where each one of the e-Type 3 CBs transmits a sub-set of CCs. The communications device may select the HARQ-ACK codebook that can retransmit the most cancelled HARQ-ACKs. In some embodiments, if there is more than one HARQ-ACK CB meeting this condition, the HARQ-ACK codebook with the smallest size is selected.

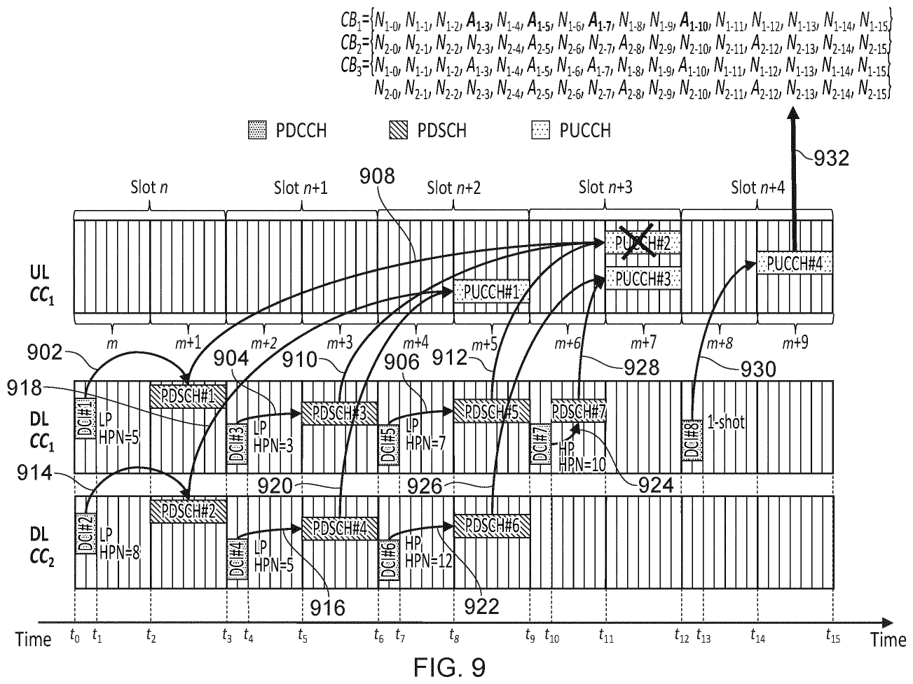

An example of HARQ-ACK codebook selection based on CC containing cancelled HPNs on a grid of communications resources is schematically represented in FIG. 9. In FIG. 9, a communications device is configured with two CCs, namely, CC₁ and CC₂. The upper third of FIG. 9 represents uplink radio resources for CC₁, the middle third of FIG. 9 represents downlink radio resources for CC₁ and the lower third of FIG. 9 represents downlink radio resources for CC₂. Uplink radio resources for CC₂ are not shown in FIG. 9 for clarity. CC₁ is a primary carrier and carries the UL HARQ-ACKs for all CCs.

As shown in FIG. 9, the communications device is configured with three e-Type 3 CBs, CB₁, CB₂ and CB₃ where CB₁ carries HARQ-ACKs for CC₁, CB₂ carries HARQ-ACKs for CC₂ and CB₃ carries HARQ-ACKs for CC₁ and CC₂.

In FIG. 9, DCI #1, DCI #3 and DCI #5 in CC₁ respectively schedule PDSCH #1, PDSCH #3 and PDSCH #5 as represented by respective arrows 902, 904, 906. PDSCH #1, PDSCH #3 and PDSCH #5 are respectively assigned HPN 5, 3 and 7. Each of DCI #1, DCI #3 and DCI #5 in CC₁ respectively indicate LP PUCCH #2 in sub-slot m+7 for transmitting HARQ-ACK for each of PDSCH #1, PDSCH #3 and PDSCH #5 as represented by respective arrows 908, 910, 912.

In CC₂, DCI #2 and DCI #4 respectively schedule PDSCH #2 and PDSCH #4 as represented by respective arrows 914, 916. PDSCH #2 and PDSCH #4 are respectively assigned HPN 8 and 5. Each of DCI #2 and DCI #4 respectively indicate LP PUCCH #1 in sub-slot m+5 for transmitting HARQ-ACK for each of PDSCH #2 and PDSCH #4 as represented by respective arrows 918 and 920.

DCI #6 in CC₂ and DCI #7 in CC₁ respectively schedule PDSCH #6 and PDSCH #7 as represented by respective arrows 922 and 924. PDSCH #6 and PDSCH #7 are respectively assigned HPN 12 and 10. Each of DCI #6 and DCI #7 respectively indicate HP PUCCH #3 in sub-slot m+7 for transmitting HARQ-ACK for each of PDSCH #6 and PDSCH #7 as represented by respective arrows 926 and 928.

As shown in FIG. 9, HP PUCCH #3 collides with LP PUCCH #2. Since PUCCH #2 has a lower priority than PUCCH #3, PUCCH #2 is dropped. In other words, the HARQ-ACKs for PDSCH #1, PDSCH #3 and PDSCH #5 are cancelled. DCI #8 contains a 1-shot trigger for an e-Type 3 CB. As represented by arrow 930, DCI #8 indicates PUCCH #4 for transmitting cancelled HARQ-ACKs. In response, the communications device selects one of CB₁, CB₂ or CB₃ for retransmitting the cancelled HARQ-ACKs. In the example described with reference to FIG. 9, all of the cancelled HARQ-ACKs belong to CC₁. CB₁ and CB₃ are both capable of carrying the cancelled HARQ-ACKs which belong to CC₁. Therefore, the communications device may select one of CB₁ and CB₃ for retransmitting the cancelled HARQ-ACK. In some embodiments, the communications device may select CB₁ over CB₃ because CB₁ has a smaller size than CB₃. The retransmission of the cancelled HARQ-ACKs using CB₁ is represented by arrow 932.

As shown in FIG. 9, PDSCH #7 is assigned an HPN of 10 and the HARQ-ACK for PDSCH #7 was successfully transmitted in HP PUCCH #3. As shown in FIG. 9, CB₁ carries HARQ-ACK for HPN 10. Therefore, even though the HARQ-ACK for PDSCH #7 was successfully transmitted, the HARQ-ACK for PDSCH #7 will be retransmitted because CB₁ was selected.

### Order of PDSCH Scheduling

In example embodiments, the one or more conditions for selecting the HARQ-ACK codebooks is a condition on the scheduling time order of the PDSCHs of the cancelled HARQ-ACKs.

In example embodiments, the scheduling time order of the PDSCHs of the cancelled HARQ-ACK corresponds to later PDSCHs. In other words, the communications device selects the HARQ-ACK codebook that can carry the most cancelled HARQ-ACKs corresponding to the latest PDSCHs. In such embodiments, the communications device prioritises HARQ-ACKs for later PDSCHs. The selection procedure may be summarized as follows:
The communications device determines which HARQ-ACK codebooks contain the latest PDSCH. These HARQ-ACK codebooks form a set of HARQ-ACK codebooks Sₗₐₜₑₛₜ.
If the set, Sₗₐₜₑₛₜ, contains more than one element, the communications device then determines (as a “tiebreak”), the subset Sₗₐₜₑₛₜ₂ that contains the second latest PDSCH.
The process of determining smaller and smaller subsets continues until the subset contains only one element. The HARQ-ACK codebook associated with that subset is the one that is used for transmission in the PUCCH.

In some embodiments, if at the end of the selection process there is more than one HARQ-ACK codebook remaining as a candidate to be selected, then either
The communications device chooses the HARQ-ACK codebook with the lowest index (e.g. CB₁); or
The communications device chooses the HARQ-ACK codebook with the highest index (e.g. CB₃); or
The communications device chooses the HARQ-ACK codebook with the largest number of cancelled HARQ-ACKs.

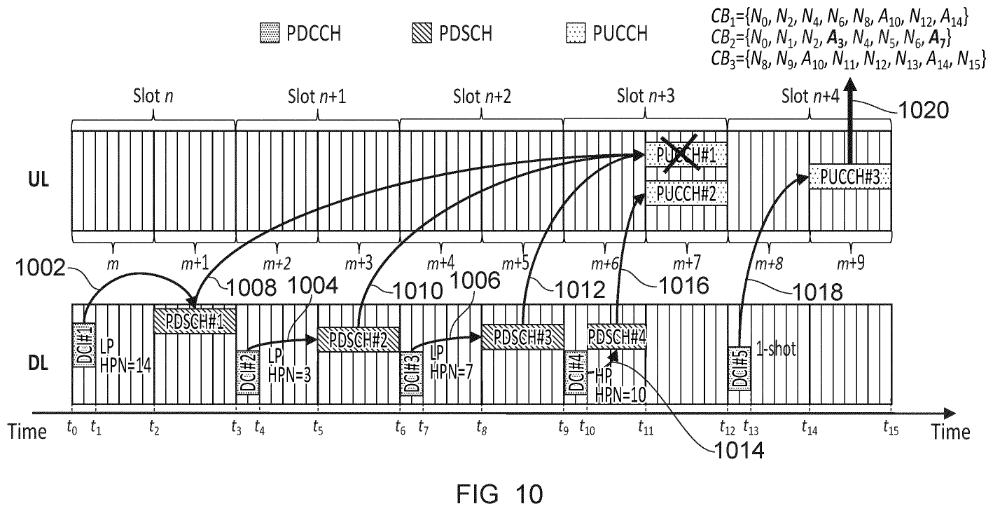

An example of selecting a HARQ-ACK codebook with the most cancelled HARQ-ACK corresponding to later PDSCHs on a grid of communications resources is schematically represented in FIG. 10. In FIG. 10, the communications device is configured with three e-Type 3 CBs, CB₁, CB₂ and CB₃ as follows:
CB₁ carries even numbered HPNs, i.e., HPN={0, 2, 4, 6, 8, 10, 12, 14}
CB₂ carries the lower half of the HPNs, i.e., HPN={0, 1, 2, 3, 4, 5, 6, 7}
CB₃ carries the upper half of the HPNs, i.e., HPN={8, 9, 10, 11, 12, 13, 14, 15}

As shown in FIG. 10, DCI #1, DCI #2 and DCI #3 respectively schedule PDSCH #1, PDSCH #2 and PDSCH #3 as represented by respective arrows 1002, 1004 and 1006. Each of DCI #1, DCI #2 and DCI #3 indicates LP PUCCH #1 in sub-slot m+7 for carrying HARQ-ACK for each of PDSCH #1, PDSCH #2 and PDSCH #3 as represented by respective arrows 1008, 1010 and 1012.

As shown in FIG. 10, PDSCH #1, PDSCH #2 and PDSCH #3 are assigned with HPN 14, 3 and 7 respectively. DCI #4 schedules PDSCH #4 as represented by arrow 1014. PDSCH #4 is assigned HPN 10. DCI #4 indicates HP PUCCH #2 for transmitting HARQ-ACK for PDSCH #4 as represented by arrow 1016. As shown in FIG. 10, HP PUCCH #2 collides with PUCCH #1. Since PUCCH #1 has lower priority than PUCCH #2, PUCCH #1 is dropped. In other words, the HARQ-ACK for each of PDSCH #1, PDSCH #2 and PDSCH #3 is cancelled. DCI #5 triggers an e-Type 3 CB using the 1-shot indictor. As represented by arrow 1018, DCI #5 indicates PUCCH #3 for retransmitting cancelled HARQ-ACKs.

It will be appreciated from the above description of the configured HARQ-ACK codebooks that none of the configured HARQ-ACK Codebooks can retransmit all the cancelled HARQ-ACKs. Therefore, in accordance with example embodiments, the communications device selects CB₂ for retransmitting cancelled HARQ-ACK because it carries the HARQ-ACK associated with the latest PDSCH (PDSCH #3 associated with HPN=7). The transmission of the cancelled HARQ-ACKs using CB₂ is represented by arrow 1020. In some embodiments, if more than one HARQ-ACK Codebook is carrying the HARQ-ACK for the latest PDSCH, then the communications device may select the HARQ-ACK Codebook that also carries the HARQ-ACK for the second latest PDSCH (i.e. PDSCH #2) and so on.

In example embodiments, the scheduling time order of the PDSCHs of the cancelled HARQ-ACK corresponds to earlier PDSCHs. In other words, the communications device selects the HARQ-ACK Codebook that can carry the most cancelled HARQ-ACKs corresponding to the earliest PDSCHs. In other words, the communications device prioritises HARQ-ACKs corresponding to earlier PDSCHs. The selection procedure is summarized in the following way:
The communications device determines which HARQ-ACK codebooks contain the earliest PDSCH. These HARQ-ACK codebooks form a set of HARQ-ACK codebooks Sₑₐᵣₗᵢₑₛₜ.
If the set, Sₑₐᵣₗᵢₑₛₜ, contains more than one element, the communications device then determines (as a “tiebreak”), the subset Sₑₐᵣₗᵢₑₛₜ₂ that contains the second earliest PDSCH.
The process of determining smaller and smaller subsets continues until the subset contains only one element. The HARQ-ACK codebook associated with that subset is the one that is used for transmission in the PUCCH.

In some embodiments, if at the end of the selection process there is more than one HARQ-ACK codebook remaining as a candidate to be selected, then either:
The communications device chooses the HARQ-ACK codebook with the lowest index (e.g. CB₁); or
The communications device chooses the HARQ-ACK codebook with the highest index (e.g. CB₃); or
The communications device chooses the HARQ-ACK codebook with the largest number of cancelled HARQ-ACKs.

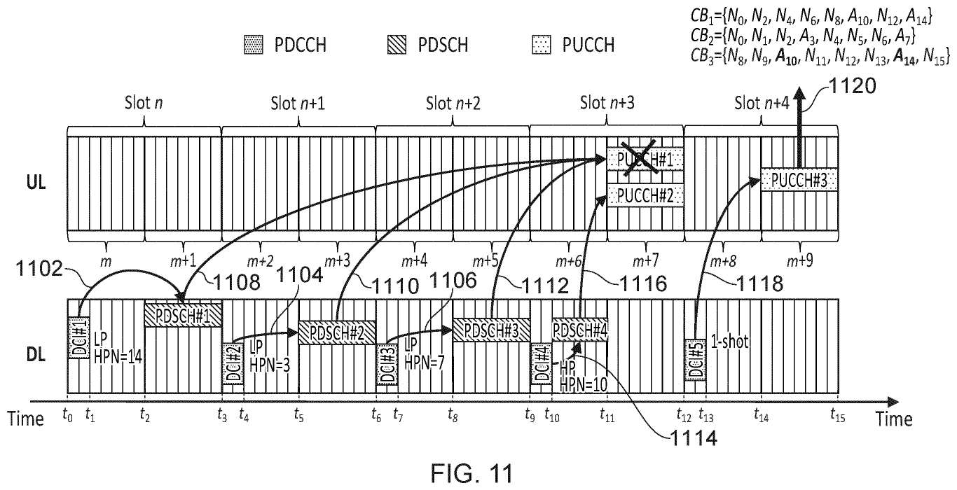

An example of selecting a HARQ-ACK codebook with the most cancelled HARQ-ACK corresponding to earlier PDSCHs on a grid of communications resources is schematically represented in FIG. 11. FIG. 11 is based on FIG. 10 and, in particular, the steps represented by arrows 1102, 1104, 1106, 1108, 1110, 1112, 1114, 1116 and 1118 in FIG. 11 correspond to the steps represented by respective arrows 1002, 1004, 1006, 1008, 1010, 1012, 1014, 1016 and 1018 in FIG. 10.

In the example described with reference to FIG. 11, the communications device may select either CB₁ or CB₃ because, even though CB₃ and CB₁ carry less cancelled HARQ-ACK than CB₂, CB₃ and CB₁ contain the HARQ-ACK for the earliest PDSCH (PDSCH #1 that is associated with HPN=14). As explained above, in some embodiments, the communications device may select between CB₁ and CB₃ based on which codebook has the higher index. In the example described with reference to FIG. 11, the communications device selects CB₃ over CB₁ because CB₃ has a higher index than CB₁. Arrow 1120 therefore represents the transmission of the cancelled HARQ-ACKs using CB₃.

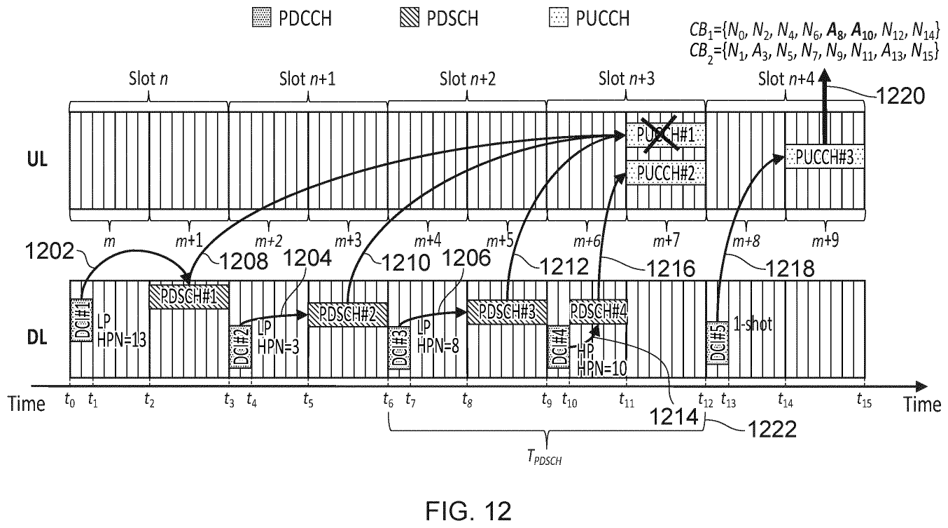

In example embodiments, the scheduling time order of the PDSCHs of the cancelled HARQ-ACKs falls within a pre-defined time window, T_{PDSCH}. That is, the communications device selects the HARQ-ACK Codebook that can carry the most cancelled HARQ-ACKs whose corresponding PDSCHs fall within time window T_{PDSCH}. The time window T_{PDSCH} can be indicated in the DCI, RRC configured or fixed in the specifications. An example is shown in FIG. 12, where the communications device is configured with two e-Type 3 CBs as follows:
CB₁ carries even numbered HPNs, i.e. HPN={0, 2, 4, 6, 8, 10, 12, 14}
CB₂ carries odd numbered HPNs, i.e., HPN={1, 3, 5, 7, 9, 11, 13, 15}

An example of selecting a HARQ-ACK codebook with the most cancelled HARQ-ACKs corresponding to PDSCHs within T_{PDSCH} on a grid of communications resources is schematically represented in FIG. 12.

As shown in FIG. 12, DCI #1, DCI #2 and DCI #3 respectively schedule PDSCH #1, PDSCH #2 and PDSCH #3 as represented by respective arrows 1202, 1204 and 1206. Each of DCI #1, DCI #2 and DCI #3 indicates LP PUCCH #1 in sub-slot m+7 for carrying HARQ-ACK for each of PDSCH #1, PDSCH #2 and PDSCH #3 as represented by respective arrows 1208, 1210 and 1212.

As shown in FIG. 12, PDSCH #1, PDSCH #2 and PDSCH #3 are assigned with HPN 13, 3 and 8 respectively. DCI #4 schedules PDSCH #4 as represented by arrow 1214. PDSCH #4 is assigned HPN 10. DCI #4 indicates HP PUCCH #2 for transmitting HARQ-ACK for PDSCH #4 as represented by arrow 1216. As shown in FIG. 12, HP PUCCH #2 collides with PUCCH #1. Since PUCCH #1 has lower priority than PUCCH #2, PUCCH #1 is dropped. In other words, the HARQ-ACK for each of PDSCH #1, PDSCH #2 and PDSCH #3 is cancelled. DCI #5 triggers an e-Type 3 CB using the 1-shot indictor. As represented by arrow 1218, DCI #5 indicates PUCCH #3 for retransmitting the cancelled HARQ-ACKs.

A pre-defined time window, T_{PDSCH}, 1222 is illustrated in FIG. 12. The pre-defined time window 1222 in this example is two slots prior to the start of the DCI that triggers the e-Type 3 CB (i.e. DCI #5). In other words, the pre-defined time window 1222 covers Slot n+2 and Slot n+3. In some embodiments, the communications device selects CB₁ over CB₂ since CB₁ contains HPN 8 that corresponds to the PDSCH #3, which is within the pre-defined time window 1222. This is the case even though CB₂ carries more cancelled HARQ-ACKs. It will be appreciated that the pre-defined time window 1222 can have a different range.

For example, in other embodiments, the pre-defined time window 1222 may cover sub-slot m+1 to m+4 instead of Slot n+2 and Slot n+3. Arrow 1220 represents the transmission of the cancelled HARQ-ACKs using CB₁.

### L1 Priority

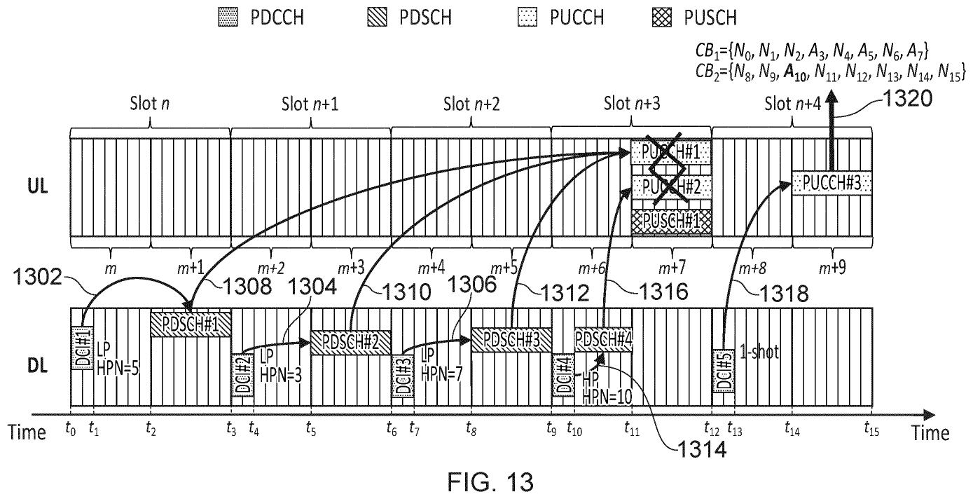

In example embodiments, the one or more conditions for selecting the HARQ-ACK codebook includes a condition on the L1 priority of the cancelled HARQ-ACKs. In other words, a communications device selects the HARQ-ACK Codebook that carries the most cancelled HARQ-ACKs with a pre-determined L1 priority. As will be appreciated by one skilled in the art, L1 may mean “Layer 1” or “Physical Layer”. The pre-determined L1 priority can be indicated in the DCI, RRC configured or fixed in the specifications. For example, in Release-16 of the 3GPP standards, there are two L1 priorities, namely, Low and High. An example of selecting the HARQ-ACK Codebook that carries the most cancelled HARQ-ACKs with a pre-determined L1 priority is shown in FIG. 13, where a first communications device is configured with two e-Type 3 CBs as follows:
CB₁ carries the lower half of the HPNs, i.e., HPN={0, 1, 2, 3, 4, 5, 6, 7}
CB₂ carries the upper half of the HPNs, i.e., HPN={8, 9, 10, 11, 12, 13, 14, 15}

In FIG. 13, DCI #1, DCI #2, DCI #3 and DCI #4 are transmitted by a gNB to a first communications device. DCI #1, DCI #2 and DCI #3 respectively schedule PDSCH #1, PDSCH #2 and PDSCH #3 as represented by respective arrows 1302, 1304 and 1306. Each of DCI #1, DCI #2 and DCI #3 indicates LP PUCCH #1 in sub-slot m+7 for carrying HARQ-ACK for each of PDSCH #1, PDSCH #2 and PDSCH #3 as represented by respective arrows 1308, 1310 and 1312.

As shown in FIG. 13, PDSCH #1, PDSCH #2 and PDSCH #3 are assigned with HPN 5, 3 and 7 respectively. DCI #4 schedules PDSCH #4 as represented by arrow 1314. PDSCH #4 is assigned HPN 10. DCI #4 indicates HP PUCCH #2 for transmitting HARQ-ACK for PDSCH #4 as represented by arrow 1316.

The gNB also schedules a PUSCH #1 for a second communications device that has higher priority than the first communications device. The gNB may also transmit an UL CI to the first communications device instructing the first communications device to cancel its uplink transmissions. In response, the first communications device drops all of its scheduled HARQ-ACK. In other words, the first communications device does not transmit the HARQ-ACKs which were scheduled to be transmitted in PUCCH #1 and PUCCH #2.

The gNB transmits a 1-shot trigger using DCI #5 for the first communications device to retransmit its cancelled HARQ-ACKs in PUCCH #3 as represented by arrow 1318. In some embodiments, the gNB may indicate a preference for cancelled HARQ-ACK that has High L1 priority. As such, the first communications device selects CB₂ over CB₁ since CB₂ contains more cancelled HP HARQ-ACKs than CB₁. This is the case even though CB₂ carries less cancelled HARQ-ACKs than CB₁. In other embodiments, the gNB may indicate a preference for LP HARQ-ACKs.

One-Shot Trigger with PDSCH Scheduling

In previous example embodiments, the DCI indicating the one-shot trigger does not schedule any PDSCHs. In other example embodiments, the DCI carrying the one-shot trigger can also schedule one or more PDSCHs (e.g. multiple PDSCHs using MIMO) as explained in more detail below.

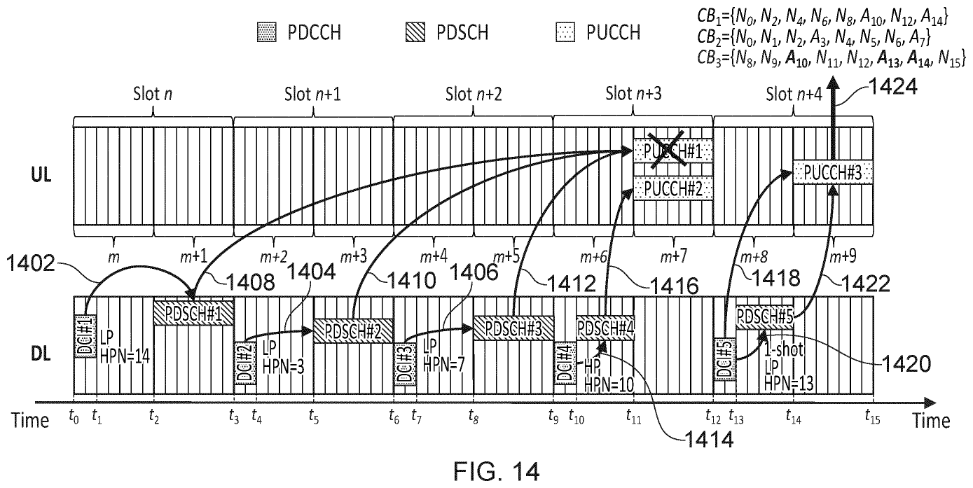

In example embodiments, if the DCI triggering a HARQ-ACK retransmission (e.g. using a one-shot trigger) also schedules one or more PDSCHs, the communications device will select the HARQ-ACK Codebook that contains at least the HARQ-ACK for PDSCH of the DCI which schedules the HARQ-ACK retransmission. In other words, the communications device prioritises the HARQ-ACK for PDSCHs which are scheduled together with the trigger over cancelled HARQ-ACKs for other PDSCHs. An example is shown in FIG. 14, where the communications device is configured with three e-Type 3 CBs as follows:
CB₁ carries even numbered HPNs, i.e., HPN={0, 2, 4, 6, 8, 10, 12, 14}
CB₂ carries the lower half of the HPNs, i.e., HPN={0, 1, 2, 3, 4, 5, 6, 7}
CB₃ carries the upper half of the HPNs, i.e., HPN={8, 9, 10, 11, 12, 13, 14, 15}

An example where a DCI with a 1-shot trigger which also schedules a PDSCH on a grid of communications resources is schematically represented in FIG. 14. As shown in FIG. 14, DCI #1, DCI #2 and DCI #3 respectively schedule PDSCH #1, PDSCH #2 and PDSCH #3 as represented by respective arrows 1402, 1404 and 1406. PDSCH #1, PDSCH #2 and PDSCH #3 are respectively assigned HPN 14, 3 and 7. Each of DCI #1, DCI #2 and DCI #3 indicate that HARQ-ACK for each of PDSCH #1, PDSCH #2 and PDSCH #3 is to be transmitted in LP PUCCH #1 in sub-slot m+7 as represented by arrows 1408, 1410 and 1412. DCI #4 schedules PDSCH #4 as represented by arrow 1414. PDSCH #4 is assigned HPN 10. DCI #4 indicates that the HARQ-ACK for PDSCH #4 is to be transmitted in HP PUCCH #2 in sub-slot m+7 as represented by arrow 1416. As shown in FIG. 14, HP PUCCH #2, collides with LP PUCCH #1 in sub-slot m+7. Since PUCCH #1 has lower L1 priority than PUCCH #2, PUCCH #1 is dropped. In other words, the HARQ-ACK for each of PDSCH #1, PDSCH #2 and PDSCH #3 is cancelled. As shown in FIG. 14, the gNB transmits DCI #5 containing a 1-shot trigger. DCI #5 indicates that cancelled HARQ-ACK is to be transmitted in PUCCH #3 as represented by arrow 1418. DCI #5 also schedules PDSCH #5 as represented by arrow 1420. PDSCH #5 is assigned HPN 13. Furthermore, DCI #5 indicates that the HARQ-ACK for PDSCH #5 is to be transmitted in PUCCH #3 as represented by arrow 1422.

In accordance with example embodiments, the communications device selects CB₃ over CB₁ or CB₂ because CB₃ contains the HARQ-ACK for HPN 13 which is assigned for PDSCH #5. This is the case even though CB₃ carries less cancelled HARQ-ACKs (i.e. carries HARQ-ACK for HPN 14 which was assigned to PDSCH #1) compared to CB₂ (which carries HARQ-ACK for HPN 3 and HPN 7 which were assigned for PDSCH #2 and PDSCH #3 respectively). As represented by arrow 1424, the cancelled HARQ-ACK for HPN 14, as well as the HARQ-ACKs for HPN 10 and 13, are transmitted using CB₃.

In example embodiments, the DCI that indicates the one-shot trigger and also schedules PDSCHs can schedule separate PUCCHs for HARQ-ACKs corresponding to those scheduled PDSCHs and for retransmission of cancelled HARQ-ACKs.

In example embodiments, where the DCI schedules PDSCH together with the one-shot trigger, the communications device selects the CB that contains HARQ-ACK for that scheduled PDSCH only if the PUCCH carrying this HARQ-ACK also carries retransmissions for cancelled HARQ-ACK. In other words, if the one-shot trigger schedules two PUCCHs, then the communications device does not need to prioritise for the non-cancelled HARQ-ACKs.

### Non-Cancelled HARQ-ACK

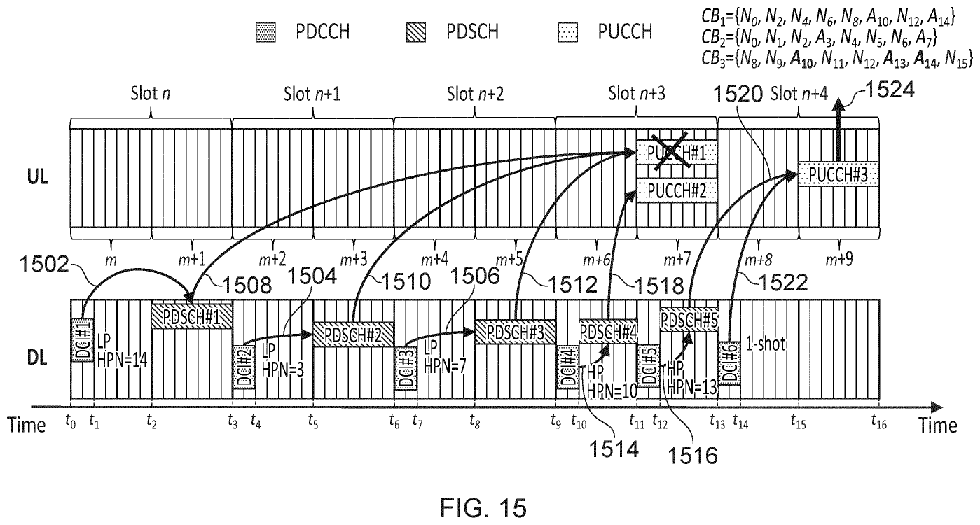

In example embodiments, if non-cancelled HARQ-ACKs are scheduled to be transmitted in the PUCCH that is triggered to carry retransmission of cancelled HARQ-ACKs, the communications device will select the CB containing non-cancelled HARQ-ACKs first before using one of the above embodiments for cancelled HARQ-ACKs. An example is shown in FIG. 15, where the communications device is configured with three e-Type 3 CBs as follows:
CB₁ carries even numbered HPNs, i.e., HPN={0, 2, 4, 6, 8, 10, 12, 14}
CB₂ carries the lower half of the HPNs, i.e., HPN={0, 1, 2, 3, 4, 5, 6, 7}
CB₃ carries the upper half of the HPNs, i.e., HPN={8, 9, 10, 11, 12, 13, 14, 15}

An example embodiment of non-cancelled HARQ-ACKs and cancelled HARQ-ACKs being scheduled in the same PUCCH on a grid of communications resources is schematically represented in FIG. 15. As shown in FIG. 15, DCI #1, DCI #2 and DCI #3 respectively schedule PDSCH #1, PDSCH #2 and PDSCH #3 as represented by respective arrows 1502, 1504, 1506. PDSCH #1, PDSCH #2 and PDSCH #3 are respectively assigned HPN 14, 3 and 7. Each of DCI #1, DCI #2 and DCI #3 indicates that HARQ-ACK for each of PDSCH #1, PDSCH #2 and PDSCH #3 is to be carried by LP PUCCH #1 in sub-slot m+7 as represented by arrows 1508, 1510 and 1512. DCI #4 and DCI #5 respectively schedule PDSCH #4 and PDSCH #5 as represented by arrows 1514 and 1516. PDSCH #4 and PDSCH #5 are respectively assigned HPN 10 and 13. DCI #4 indicates that HARQ-ACK for PDSCH #4 is to be carried by HP PUCCH #2 as represented by arrow 1518. DCI #5 indicates that HARQ-ACK for PDSCH #5 is to be carried by HP PUCCH #3 as represented by arrow 1520.

As shown in FIG. 15, PUCCH #2 collides with PUCCH #1 in sub-slot m+7. PUCCH #1 is dropped since PUCCH #1 has a lower L1 priority than PUCCH #2. In other words, the HARQ-ACK for each of PDSCH #1, PDSCH #2 and PDSCH #3 is cancelled. The gNB sends a one-shot trigger in DCI #6 triggering an e-Type 3 CB. DCI #6 indicates that the cancelled HARQ-ACKs are to be transmitted in PUCCH #3 as represented by arrow 1522. In some embodiments, the communications device selects CB₃ over CB₁ and CB₂ because CB₃ contains the non-cancelled HARQ-ACK corresponding to PDSCH #5 with HPN 13. This is the case even though CB₃ carries less cancelled HARQ-ACK (i.e. carries HARQ-ACKs for HPN 14 which was assigned for PDSCH #1) compared to CB₂ (which carries HARQ-ACKs for HPN 3 and HPN 7 which were assigned for PDSCH #2 and PDSCH #3 respectively).

It will be appreciated that the above embodiments can be implemented individually or combined. For example, the communications device can be combined to consider a time window T_{PDSCH} and the CC.

It will be appreciated that although example embodiments have been described with respect to an e-Type 3 CB, the present disclosure is not so limited. Example embodiments may be applied to other HARQ-ACK Codebooks that are configured in the communications device and can be selected, e.g. the new dynamic ReTx CB. It will also be appreciated that although example embodiments have been described where two or 3 e-Type 3 CBs have been configured for a communications device, the present disclosure is not so limited. Example embodiments may be applied for different numbers of configured HARQ-ACK Codebooks.

As explained above, example embodiments can reduce overhead for HARQ-ACK retransmissions while maintaining a relatively small DCI size, and without unduly limiting the number of HARQ-ACK codebooks that can be selected.

Though embodiments of the present technique have been described largely by way of the example communications systems shown in FIGS. 1 to 3, and described by way of the arrangements shown by FIGS. 8 to 15, it would be clear to those skilled in the art that they could be equally applied to other systems to those described herein.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may, without departing from the scope of the claims, form part of communications systems other than those defined by the present disclosure.

The following numbered paragraphs provide further example aspects and features of the present technique:
Paragraph 1. A method of operating a communications device to receive data from a wireless communications network, the method comprising
   receiving a plurality of downlink transmissions in physical downlink shared channel resources of a wireless access interface provided by the wireless communications network, each downlink transmission being a transmission of a data unit transmitted according to a different Hybrid Automatic Repeat Request, HARQ, type process,
   determining a HARQ acknowledgement or negative acknowledgement, HARQ-ACK, for each of the plurality of received downlink transmissions in accordance with whether the data unit for the HARQ type process was correctly received or not,
   determining for each of the different HARQ-type processes for each of the plurality of received downlink transmissions of the data units, the HARQ-ACKs to be transmitted for the received downlink data units,
   determining that an uplink transmission of the HARQ-ACKs, which is scheduled in uplink resources of the wireless access interface, is cancelled and cannot be transmitted in the scheduled uplink resources,
   receiving a trigger from the wireless communications network to transmit the cancelled HARQ-ACKs in subsequently scheduled uplink resources, and
   in response to the trigger, selecting one of a plurality of configured HARQ-ACK codebooks to transmit the cancelled HARQ ACKs, wherein the configured HARQ-ACK codebook is selected based on one or more conditions.
Paragraph 2. A method according to paragraph 1, wherein the one or more conditions comprises a number of the cancelled HARQ-ACKs for one or more of the received downlink data units of the different HARQ-type processes, which can be carried by the configured HARQ-ACK codebook.
Paragraph 3. A method according to paragraph 2, wherein each of the plurality of HARQ-ACK codebooks configured for transmitting the cancelled HARQ ACKs is associated with a different threshold number representing a number of the cancelled HARQ ACKs to be transmitted, and the selecting the configured HARQ-ACK codebook comprises comparing the number of the cancelled HARQ-ACKs to be transmitted with each associated threshold number for the configured HARQ-ACK codebook and selecting a corresponding one of the plurality of configured HARQ ACK codebooks based on the associated threshold.
Paragraph 4. A method according to paragraph 3, comprising receiving the threshold number representing the number of cancelled HARQ-ACKs for each of the plurality of HARQ-ACK codebooks via Radio Resource Control, RRC, signals from the wireless communications network.
Paragraph 5. A method according to paragraph 3 or 4, wherein one or more of the plurality of HARQ-ACK codebooks is configured according to a different codebook type, and if the number of cancelled HARQ-ACKs to be transmitted is less than a first threshold number, associated with a dynamically configured HARQ-ACK codebook type, the selecting the configured HARQ-ACK codebook comprises selecting the HARQ-ACK codebook type which will carry only the cancelled HARQ-ARQ of the one received downlink data units, the HARQ-ACK codebook type being dynamically configured using downlink control information.
Paragraph 6. A method according to any of paragraphs 3 to 5, wherein one or more of the plurality of HARQ-ACK codebooks is configured according to a different codebook type, and if the number of cancelled HARQ-ACKs to be transmitted is greater than a second threshold number, associated with a HARQ-ACK codebook type configured to carry different numbers of HARQ-ACKs, the selecting one of the plurality of configured HARQ-ACK codebooks comprises selecting one of a plurality of HARQ codebooks of a type which has been configured to carry a number of the determined HARQ-ACKs for the plurality of received of downlink data units which exceeds the second threshold number associated with the selected HARQ-ACK codebook.
Paragraph 7. A method according to paragraph 6, wherein the type of the plurality of HARQ codebooks which has been configured to carry the number of the cancelled HARQ-ACK retransmissions is semi-statically configured by radio resource control, RRC, signalling and indicated in downlink control information.
Paragraph 8. A method according to paragraph 1, wherein each of the different HARQ processes is associated with a different HARQ process number from a set of HARQ process numbers, and the one or more conditions for selecting the configured HARQ-ACK codebooks is based on the HARQ process numbers of the HARQ processes for the received downlink data units for which the HARQ-ACKs were cancelled.
Paragraph 9. A method according to paragraph 8, comprising
   receiving the HARQ process number for each of the HARQ processes via Radio Resource Control, RRC, signals from the wireless communications network.
Paragraph 10. A method according to paragraph 8 or 9, wherein each of the plurality of HARQ-ACK codebooks is configured to carry a HARQ-ACK for a plurality of HARQ processes which have a subset of different HARQ process numbers from the set of HARQ process numbers, wherein the selecting the configured HARQ-ACK codebook from the plurality of configured HARQ-ACK codebooks comprises selecting a configured HARQ-ACK codebook based on the sub-set of the HARQ process numbers which include one or more of the same HARQ process numbers of the cancelled HARQ-ACKs.
Paragraph 11. A method according to paragraph 10, wherein the one or more conditions comprises a greatest number of the cancelled HARQ-ACKs with HARQ process numbers which can be carried by a HARQ-ACK codebook and the selecting the one of the plurality of configured HARQ-ACK codebooks comprises
   identifying the HARQ process number of the HARQ process for each of the cancelled HARQ-ACK of the plurality of received downlink data units,
   identifying which of the configured HARQ-ACK codebooks can carry a greatest number of the cancelled HARQ-ACKs, based on the subset of HARQ process numbers which each configured HARQ-ACK codebooks can carry, and
   selecting the configured HARQ-ACK codebook which can carry the greatest number of the HARQ-ACKs for the plurality of received of downlink transmissions.
Paragraph 12. A method according to paragraph 11, wherein the selecting the configured HARQ-ACK codebook which can carry the greatest number of the HARQ-ACKs for the plurality of received of downlink transmissions comprises
   if the greatest number of the HARQ-ACK retransmissions can be carried by more than one of the configured HARQ-ACK codebooks, selecting the configured HARQ-ACK codebook which can carry the greatest number of HARQ retransmissions and which has the smallest size.
Paragraph 13. A method according to any of paragraphs 1 to 12, wherein the receiving the plurality of downlink transmissions of the data units according to the different HARQ type process comprises
   receiving the plurality of downlink transmissions of the data units according to the different HARQ type processes from a downlink part of a plurality of component carriers, and one or more of the plurality of configured HARQ-ACK codebooks are configured to carry HARQ-ACKs for downlink transmissions for HARQ processes transmitted on a sub-set of the plurality of component carriers, the one or more conditions for selecting the configured HARQ-ACK codebook being the one or more component carriers on which the received downlink transmissions were transmitted and the cancelled HARQ-ACKs are being retransmitted.
Paragraph 14. A method according to paragraph 13, comprising
   receiving the sub-set of the plurality of component carriers via Radio Resource Control, RRC, signals from the wireless communications network.
Paragraph 15. A method according to paragraph 13 or 14, wherein the selecting of the one of the plurality of configured HARQ-ACK codebooks comprises
   selecting the configured HARQ-ACK codebook which can carry a greatest number of cancelled HARQ-ACK retransmissions.
Paragraph 16. A method according to paragraph 15, wherein the selecting the one of the plurality of configured HARQ-ACK codebooks comprises
   if the greatest number of the cancelled HARQ-ACK retransmissions can be carried by more than one of the configured HARQ-ACK codebooks, selecting the configured HARQ-ACK codebook which can carry the greatest number of cancelled HARQ retransmissions and which has the smallest size.
Paragraph 17. A method according to any of paragraphs 1 to 16, wherein the selecting the one of the plurality of configured HARQ-ACK codebooks comprises
   identifying the HARQ-ACK codebook which can carry one or more of the cancelled HARQ-ACKs for retransmission of a received downlink data unit transmitted later in time, which are more recent, than cancelled HARQ-ACKs for retransmission of a received downlink data units transmitted earlier in time, which are older, and
   selecting the configured HARQ-ACK codebook which can carry the cancelled HARQ-ACKs later in time.
Paragraph 18. A method according to paragraph 17, wherein the identifying the HARQ-ACK codebook, which can carry one or more of the cancelled HARQ-ACKs for retransmission of a received downlink data unit transmitted later time, comprises
   determining which of the configured HARQ-ACK codebooks can carry a cancelled HARQ-ACK for retransmission of a received downlink data unit transmitted latest in time, being the most recent,
   forming a first set, Sₗₐₜₑₛₜ, of configured HARQ-ACK codebooks that can carry the cancelled HARQ-ACK for retransmission of a received downlink data unit latest in time,
   if the first set, Sₗₐₜₑₛₜ, contains more than one configured HARQ-ACK codebook, determining which of the configured HARQ-ACK codebooks can carry a cancelled HARQ-ACK for retransmission of a received downlink data unit transmitted which is next latest in time, being the next most recent,
   forming a next set, Sₗₐₜₑₛₜ₂, of configured HARQ-ACK codebooks, from the first set, Sₗₐₜₑₛₜ, which can carry the cancelled HARQ-ACK for retransmission of a received downlink data unit next latest in time, and
   repeating the determining the configured HARQ-ACK codebooks, from the next set which can carry a cancelled HARQ-ACK for retransmission of a next latest received downlink data unit until one of the configured HARQ-ACK codebook is identified for selection.
Paragraph 19. A method according to any of paragraphs 1 to 18, wherein the selecting the one of the plurality of configured HARQ-ACK codebooks comprises
   identifying the HARQ-ACK codebook which can carry one or more of the cancelled HARQ-ACKs for retransmission of a received downlink data unit transmitted earlier in time, which are older, than cancelled HARQ-ACKs for retransmission of a received downlink data units transmitted later in time, which are more recent, and
   selecting the configured HARQ-ACK codebook which can carry the cancelled HARQ-ACKs earlier in time.
Paragraph 20. A method according to paragraph 19, wherein the identifying the HARQ-ACK codebook, which can carry one or more of the cancelled HARQ-ACKs for retransmission of a received downlink data unit transmitted earlier time, comprises
   determining which of the configured HARQ-ACK codebooks can carry a cancelled HARQ-ACK for retransmission of a received downlink data unit transmitted earliest in time, being the oldest,
   forming a first set, Sₑₐᵣₗᵢₑₛₜ, of configured HARQ-ACK codebooks that can carry the cancelled HARQ-ACK for retransmission of a received downlink data unit earliest in time,
   if the first set, Sₑₐᵣₗᵢₑₛₜ, contains more than one configured HARQ-ACK codebook, determining which of the configured HARQ-ACK codebooks can carry a cancelled HARQ-ACK for retransmission of a received downlink data unit transmitted which is next earliest in time, being the next oldest,
   forming a next set, Sₑₐᵣₗᵢₑₛₜ₂ of configured HARQ-ACK codebooks, from the first set, Sₑₐᵣₗᵢₑₛₜ, which can carry the cancelled HARQ-ACK for retransmission of a received downlink data unit next earliest in time, and
   repeating the determining the configured HARQ-ACK codebooks, from the next set which can carry a cancelled HARQ-ACK for retransmission of a next earliest received downlink data unit until one of the configured HARQ-ACK codebook is identified for selection.
Paragraph 21. A method according to any of paragraphs 1 to 20, wherein the selecting the one of the plurality of configured HARQ-ACK codebooks comprises
   identifying the HARQ-ACK codebook which can carry a greatest number of one or more of the cancelled HARQ-ACKs for retransmission of a received downlink data unit transmitted in a pre-defined time window, T_{PDSCH}, and
   selecting the configured HARQ-ACK codebook which can carry the greatest number of the cancelled HARQ-ACKs within the pre-defined time window, T_{PDSCH}.
Paragraph 22. A method according to any of paragraphs 1 to 21, wherein the one or more conditions for selecting the HARQ-ACK codebook includes a priority of the scheduled uplink resources carrying the HARQ-ACK for the received downlink transmitted data units.
Paragraph 23. A method according to paragraph 22, wherein the selecting the one of the plurality of configured HARQ-ACK codebooks comprises
   identifying the HARQ-ACK codebook which can carry a greatest number of one or more of the cancelled HARQ-ACKs for retransmission of a received downlink data unit with corresponding higher priority HARQ-ACK, and
   selecting the configured HARQ-ACK codebook which can carry the greatest number of the cancelled HARQ-ACKs for retransmission of a received downlink data unit with corresponding higher priority HARQ-ACK.
Paragraph 24. A method according to paragraph 23, wherein the higher priority HARQ-ACK is layer 1, L1, priority of the scheduled uplink resources carrying the HARQ-ACK.
Paragraph 25. A method according to paragraph 22, wherein the selecting the one of the plurality of configured HARQ-ACK codebooks comprises
   identifying the HARQ-ACK codebook which can carry a greatest number of one or more of the cancelled HARQ-ACKs for retransmission of a received downlink data unit carrying lower priority HARQ-ACK, and
   selecting the configured HARQ-ACK codebook which can carry the greatest number of the cancelled HARQ-ACKs for retransmission of a received downlink data unit with corresponding lower priority data HARQ-ACK.
Paragraph 26. A method according to any of paragraphs 1 to 25, wherein the receiving the trigger from the wireless communications network to transmit the cancelled HARQ-ACKs in subsequently scheduled uplink resources, comprises
   receiving downlink control information from the wireless communications network, the downlink control information
   scheduling downlink resource of the wireless access interface for receiving one or more subsequent downlink transmissions in physical downlink shared channel resource of the wireless access interface, each of the one or more subsequent downlink transmissions being a transmission of a data unit transmitted according to a different HARQ process,
   scheduling uplink resource of the wireless access interface for transmitting the selected one of the plurality of configured HARQ-ACK codebooks, and
   the trigger to transmit the cancelled HARQ-ACKs.
Paragraph 27. A method according to paragraph 26, wherein the selecting the one of the plurality of configured HARQ-ACK codebooks includes selecting one of the configured HARQ-ACK codebooks which includes a HARQ-ACK for each of the one or more subsequent downlink transmissions of data units.
Paragraph 28. A method according to paragraph 27, wherein the selecting the one of the plurality of configured HARQ-ACK codebooks includes selecting one of the configured HARQ-ACK codebooks which includes a HARQ-ACK for each of the one or more subsequent downlink transmissions of data units and a greatest number of the cancelled HARQ-ACKs for retransmission.
Paragraph 29. A method according to any of paragraphs 1 to 28, wherein the selecting one of a plurality of configured HARQ-ACK codebooks to transmit the cancelled HARQ ACKs comprises
   determining that an attempt to transmit a HARQ-ACK for one of the received downlink transmissions of the data units has not been made;
identifying a configured HARQ-ACK codebook which can carry the HARQ-ACK for which no attempt to transmit has been made and which can carry one or more of the cancelled HARQ-ACKs; and
   selecting the configured HARQ-ACK codebook which can carry the HARQ-ACK for which no attempt to transmit has been made and which can carry one or more of the cancelled HARQ-ACKs.
Paragraph 30. A method according to any of paragraphs 1 to 29, wherein the trigger to transmit the cancelled HARQ-ACKs is a one shot trigger comprising a single bit of downlink control information.
Paragraph 31. A method of operating an infrastructure equipment in a wireless communications network to transmit data to a communications device, the method comprising
   transmitting, to the communications device, a plurality of downlink transmissions in physical downlink shared channel resources of a wireless access interface provided by the wireless communications network, each downlink transmission being a transmission of a data unit transmitted according to a different Hybrid Automatic Repeat Request, HARQ, type process, wherein the infrastructure equipment schedules a HARQ acknowledgement or negative acknowledgement, HARQ-ACK, in uplink resources of the wireless access interface for each of the plurality of transmitted downlink transmissions of the data units in accordance with whether the data unit for the HARQ type process was correctly received or not;
   configuring the communications device with a plurality of HARQ-ACK, codebooks for transmitting HARQ-ACKs;
   transmitting a trigger to the communications device to transmit cancelled HARQ-ACKs, which could not be transmitted by the communications device in the scheduled uplink resources, in subsequently scheduled uplink resources, the communications device selecting one of the plurality of configured HARQ-ACK codebooks to transmit the cancelled HARQ-ACKs based on one or more conditions.
Paragraph 32. A communications device operable to receive data from a wireless communications network, the communications device comprising
   transceiver circuitry configured to transmit and/or to receive signals;
   control circuitry configured in combination with the transceiver circuitry to
   receive a plurality of downlink transmissions in physical downlink shared channel resources of a wireless access interface provided by the wireless communications network, each downlink transmission being a transmission of a data unit transmitted according to a different Hybrid Automatic Repeat Request, HARQ, type process,
   determine a HARQ acknowledgement or negative acknowledgement, HARQ-ACK, for each of the plurality of received downlink transmissions in accordance with whether the data unit for the HARQ type process was correctly received or not,
   determine for each of the different HARQ-type processes for each of the plurality of received downlink transmissions of the data units, the HARQ-ACKs to be transmitted for the received downlink data units,
   determine that an uplink transmission of the HARQ-ACKs, which is scheduled in uplink resources of the wireless access interface, is cancelled and cannot be transmitted in the scheduled uplink resources,
   receive a trigger from the wireless communications network to transmit the cancelled HARQ-ACKs in subsequently scheduled uplink resources, and
   in response to the trigger, select one of a plurality of configured HARQ-ACK codebooks to transmit the cancelled HARQ ACKs, wherein the configured HARQ-ACK codebook is selected based on one or more conditions.
Paragraph 33. An infrastructure equipment in a wireless communications network operable to transmit data to a communications device, the infrastructure equipment comprising
   transceiver circuitry configured to transmit and/or to receive signals;
   control circuitry configured in combination with the transceiver circuitry to
   transmit, to the communications device, a plurality of downlink transmissions in physical downlink shared channel resources of a wireless access interface provided by the wireless communications network, each downlink transmission being a transmission of a data unit transmitted according to a different Hybrid Automatic Repeat Request, HARQ, type process, wherein the infrastructure equipment schedules a HARQ acknowledgement or negative acknowledgement, HARQ-ACK, in uplink resources of the wireless access interface for each of the plurality of transmitted downlink transmissions of the data units in accordance with whether the data unit for the HARQ type process was correctly received or not;
   configure the communications device with a plurality of HARQ-ACK, codebooks for transmitting HARQ-ACKs;
   transmit a trigger to the communications device to transmit cancelled HARQ-ACKs, which could not be transmitted by the communications device in the scheduled uplink resources, in subsequently scheduled uplink resources, the communications device selecting one of the plurality of configured HARQ-ACK codebooks to transmit the cancelled HARQ-ACKs based on one or more conditions.
Paragraph 34. Circuitry for a communications device operable to receive data from a wireless communications network, the circuitry comprising
   transceiver circuitry configured to transmit and/or to receive signals;
   control circuitry configured in combination with the transceiver circuitry to
   receive a plurality of downlink transmissions in physical downlink shared channel resources of a wireless access interface provided by the wireless communications network, each downlink transmission being a transmission of a data unit transmitted according to a different Hybrid Automatic Repeat Request, HARQ, type process,
   determine a HARQ acknowledgement or negative acknowledgement, HARQ-ACK, for each of the plurality of received downlink transmissions in accordance with whether the data unit for the HARQ type process was correctly received or not,
   determine for each of the different HARQ-type processes for each of the plurality of received downlink transmissions of the data units, the HARQ-ACKs to be transmitted for the received downlink data units,
   determine that an uplink transmission of the HARQ-ACKs, which is scheduled in uplink resources of the wireless access interface, is cancelled and cannot be transmitted in the scheduled uplink resources,
   receive a trigger from the wireless communications network to transmit the cancelled HARQ-ACKs in subsequently scheduled uplink resources, and
   in response to the trigger, select one of a plurality of configured HARQ-ACK codebooks to transmit the cancelled HARQ ACKs, wherein the configured HARQ-ACK codebook is selected based on one or more conditions.
Paragraph 35. Circuitry for an infrastructure equipment in a wireless communications network operable to transmit data to a communications device, the circuitry comprising
   transceiver circuitry configured to transmit and/or to receive signals;
   control circuitry configured in combination with the transceiver circuitry to
   transmit, to the communications device, a plurality of downlink transmissions in physical downlink shared channel resources of a wireless access interface provided by the wireless communications network, each downlink transmission being a transmission of a data unit transmitted according to a different Hybrid Automatic Repeat Request, HARQ, type process, wherein the infrastructure equipment schedules a HARQ acknowledgement or negative acknowledgement, HARQ-ACK, in uplink resources of the wireless access interface for each of the plurality of transmitted downlink transmissions of the data units in accordance with whether the data unit for the HARQ type process was correctly received or not;
   configure the communications device with a plurality of HARQ-ACK, codebooks for transmitting HARQ-ACKs;
   transmit a trigger to the communications device to transmit cancelled HARQ-ACKs, which could not be transmitted by the communications device in the scheduled uplink resources, in subsequently scheduled uplink resources, the communications device selecting one of the plurality of configured HARQ-ACK codebooks to transmit the cancelled HARQ-ACKs based on one or more conditions.
Paragraph 36. A wireless communications network comprising a communications device according to paragraph 32 and an infrastructure equipment according to paragraph 33.
Paragraph 37. A computer program comprising instructions which, when the program is executed by a computer, cause the computer to carry out the method of paragraph 1 or paragraph 31.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H. and Toskala A, “LTE for UMTS OFDMA and SC-FDMA based radio access”, John Wiley and Sons, 2009.
[2] TR 38.913, “Study on Scenarios and Requirements for Next Generation Access Technologies (Release 14)”, third Generation Partnership Project, v14.3.0.
[3] RP-190726, “Physical layer enhancements for NR ultra-reliable and low latency communication (URLLC)”, Huawei, HiSilicon, RAN #83.
[4] RP-201310, “Revised WID: Enhanced Industrial Internet of Things (IoT) and ultra-reliable and low latency communication (URLLC) support for NR,” Nokia, Nokia Shanghai Bell, RAN #88e.
[5] European Patent Application Number: EP20187799.0.
[6] R1-2104217, “HARQ-ACK Enhancements for IIoT/URLLC,” Ericsson, RAN1 #105e.
[7] R1-2104309, “HARQ-ACK Feedback Enhancements for URLLC/IIoT,” Nokia, Nokia Shanghai Bell, RAN1 #105e.
[8] R1-2105425, “Discussion on UE feedback enhancement for HARQ-ACK,” LG, RAN1 #105e.

1. A method of operating a communications device to receive data from a wireless communications network, the method comprising
receiving a plurality of downlink transmissions in physical downlink shared channel resources of a wireless access interface provided by the wireless communications network, each downlink transmission being a transmission of a data unit transmitted according to a different Hybrid Automatic Repeat Request, HARQ, type process,
determining a HARQ acknowledgement or negative acknowledgement, HARQ-ACK, for each of the plurality of received downlink transmissions in accordance with whether the data unit for the HARQ type process was correctly received or not,
determining for each of the different HARQ-type processes for each of the plurality of received downlink transmissions of the data units, the HARQ-ACKs to be transmitted for the received downlink data units,
determining that an uplink transmission of the HARQ-ACKs, which is scheduled in uplink resources of the wireless access interface, is cancelled and cannot be transmitted in the scheduled uplink resources,
receiving a trigger from the wireless communications network to transmit the cancelled HARQ-ACKs in subsequently scheduled uplink resources, and
in response to the trigger, selecting one of a plurality of configured HARQ-ACK codebooks to transmit the cancelled HARQ ACKs, wherein the configured HARQ-ACK codebook is selected based on one or more conditions.

2. A method according to claim 1, wherein the one or more conditions comprises a number of the cancelled HARQ-ACKs for one or more of the received downlink data units of the different HARQ-type processes, which can be carried by the configured HARQ-ACK codebook.

3. A method according to claim 2, wherein each of the plurality of HARQ-ACK codebooks configured for transmitting the cancelled HARQ ACKs is associated with a different threshold number representing a number of the cancelled HARQ ACKs to be transmitted, and the selecting the configured HARQ-ACK codebook comprises comparing the number of the cancelled HARQ-ACKs to be transmitted with each associated threshold number for the configured HARQ-ACK codebook and selecting a corresponding one of the plurality of configured HARQ ACK codebooks based on the associated threshold.

4. A method according to claim 3, comprising
receiving the threshold number representing the number of cancelled HARQ-ACKs for each of the plurality of HARQ-ACK codebooks via Radio Resource Control, RRC, signals from the wireless communications network.

5. A method according to claim 3, wherein one or more of the plurality of HARQ-ACK codebooks is configured according to a different codebook type, and if the number of cancelled HARQ-ACKs to be transmitted is less than a first threshold number, associated with a dynamically configured HARQ-ACK codebook type, the selecting the configured HARQ-ACK codebook comprises selecting the HARQ-ACK codebook type which will carry only the cancelled HARQ-ARQ of the one received downlink data units, the HARQ-ACK codebook type being dynamically configured using downlink control information.

6. A method according to claim 3, wherein one or more of the plurality of HARQ-ACK codebooks is configured according to a different codebook type, and if the number of cancelled HARQ-ACKs to be transmitted is greater than a second threshold number, associated with a HARQ-ACK codebook type configured to carry different numbers of HARQ-ACKs, the selecting one of the plurality of configured HARQ-ACK codebooks comprises selecting one of a plurality of HARQ codebooks of a type which has been configured to carry a number of the determined HARQ-ACKs for the plurality of received of downlink data units which exceeds the second threshold number associated with the selected HARQ-ACK codebook.

7. A method according to claim 6, wherein the type of the plurality of HARQ codebooks which has been configured to carry the number of the cancelled HARQ-ACK retransmissions is semi-statically configured by radio resource control, RRC, signalling and indicated in downlink control information.

8. A method according to claim 1, wherein each of the different HARQ processes is associated with a different HARQ process number from a set of HARQ process numbers, and the one or more conditions for selecting the configured HARQ-ACK codebooks is based on the HARQ process numbers of the HARQ processes for the received downlink data units for which the HARQ-ACKs were cancelled.

9. A method according to claim 8, comprising
receiving the HARQ process number for each of the HARQ processes via Radio Resource Control, RRC, signals from the wireless communications network.

10. A method according to claim 8, wherein each of the plurality of HARQ-ACK codebooks is configured to carry a HARQ-ACK for a plurality of HARQ processes which have a subset of different HARQ process numbers from the set of HARQ process numbers, wherein the selecting the configured HARQ-ACK codebook from the plurality of configured HARQ-ACK codebooks comprises selecting a configured HARQ-ACK codebook based on the sub-set of the HARQ process numbers which include one or more of the same HARQ process numbers of the cancelled HARQ-ACKs.

11. A method according to claim 10, wherein the one or more conditions comprises a greatest number of the cancelled HARQ-ACKs with HARQ process numbers which can be carried by a HARQ-ACK codebook and the selecting the one of the plurality of configured HARQ-ACK codebooks comprises
identifying the HARQ process number of the HARQ process for each of the cancelled HARQ-ACK of the plurality of received downlink data units,
identifying which of the configured HARQ-ACK codebooks can carry a greatest number of the cancelled HARQ-ACKs, based on the subset of HARQ process numbers which each configured HARQ-ACK codebooks can carry, and
selecting the configured HARQ-ACK codebook which can carry the greatest number of the HARQ-ACKs for the plurality of received of downlink transmissions.

12. A method according to claim 11, wherein the selecting the configured HARQ-ACK codebook which can carry the greatest number of the HARQ-ACKs for the plurality of received of downlink transmissions comprises
if the greatest number of the HARQ-ACK retransmissions can be carried by more than one of the configured HARQ-ACK codebooks, selecting the configured HARQ-ACK codebook which can carry the greatest number of HARQ retransmissions and which has the smallest size.

13. A method according to claim 1, wherein the receiving the plurality of downlink transmissions of the data units according to the different HARQ type process comprises
receiving the plurality of downlink transmissions of the data units according to the different HARQ type processes from a downlink part of a plurality of component carriers, and one or more of the plurality of configured HARQ-ACK codebooks are configured to carry HARQ-ACKs for downlink transmissions for HARQ processes transmitted on a sub-set of the plurality of component carriers, the one or more conditions for selecting the configured HARQ-ACK codebook being the one or more component carriers on which the received downlink transmissions were transmitted and the cancelled HARQ-ACKs are being retransmitted.

14. A method according to claim 13, comprising
receiving the sub-set of the plurality of component carriers via Radio Resource Control, RRC, signals from the wireless communications network.

15. A method according to claim 13, wherein the selecting of the one of the plurality of configured HARQ-ACK codebooks comprises
selecting the configured HARQ-ACK codebook which can carry a greatest number of cancelled HARQ-ACK retransmissions.

16. A method according to claim 15, wherein the selecting the one of the plurality of configured HARQ-ACK codebooks comprises
if the greatest number of the cancelled HARQ-ACK retransmissions can be carried by more than one of the configured HARQ-ACK codebooks, selecting the configured HARQ-ACK codebook which can carry the greatest number of cancelled HARQ retransmissions and which has the smallest size.

17. A method according to claim 1, wherein the selecting the one of the plurality of configured HARQ-ACK codebooks comprises
identifying the HARQ-ACK codebook which can carry one or more of the cancelled HARQ-ACKs for retransmission of a received downlink data unit transmitted later in time, which are more recent, than cancelled HARQ-ACKs for retransmission of a received downlink data units transmitted earlier in time, which are older, and
selecting the configured HARQ-ACK codebook which can carry the cancelled HARQ-ACKs later in time.

18. (canceled)

19. A method according to claim 1, wherein the selecting the one of the plurality of configured HARQ-ACK codebooks comprises
identifying the HARQ-ACK codebook which can carry one or more of the cancelled HARQ-ACKs for retransmission of a received downlink data unit transmitted earlier in time, which are older, than cancelled HARQ-ACKs for retransmission of a received downlink data units transmitted later in time, which are more recent, and
selecting the configured HARQ-ACK codebook which can carry the cancelled HARQ-ACKs earlier in time.

20.-31. (canceled)

32. A communications device operable to receive data from a wireless communications network, the communications device comprising
transceiver circuitry configured to transmit and/or to receive signals;
control circuitry configured in combination with the transceiver circuitry to
receive a plurality of downlink transmissions in physical downlink shared channel resources of a wireless access interface provided by the wireless communications network, each downlink transmission being a transmission of a data unit transmitted according to a different Hybrid Automatic Repeat Request, HARQ, type process,
determine a HARQ acknowledgement or negative acknowledgement, HARQ-ACK, for each of the plurality of received downlink transmissions in accordance with whether the data unit for the HARQ type process was correctly received or not,
determine for each of the different HARQ-type processes for each of the plurality of received downlink transmissions of the data units, the HARQ-ACKs to be transmitted for the received downlink data units,
determine that an uplink transmission of the HARQ-ACKs, which is scheduled in uplink resources of the wireless access interface, is cancelled and cannot be transmitted in the scheduled uplink resources,
receive a trigger from the wireless communications network to transmit the cancelled HARQ-ACKs in subsequently scheduled uplink resources, and
in response to the trigger, select one of a plurality of configured HARQ-ACK codebooks to transmit the cancelled HARQ ACKs, wherein the configured HARQ-ACK codebook is selected based on one or more conditions.

33. An infrastructure equipment in a wireless communications network operable to transmit data to a communications device, the infrastructure equipment comprising
transceiver circuitry configured to transmit and/or to receive signals;
control circuitry configured in combination with the transceiver circuitry to
transmit, to the communications device, a plurality of downlink transmissions in physical downlink shared channel resources of a wireless access interface provided by the wireless communications network, each downlink transmission being a transmission of a data unit transmitted according to a different Hybrid Automatic Repeat Request, HARQ, type process, wherein the infrastructure equipment schedules a HARQ acknowledgement or negative acknowledgement, HARQ-ACK, in uplink resources of the wireless access interface for each of the plurality of transmitted downlink transmissions of the data units in accordance with whether the data unit for the HARQ type process was correctly received or not;
configure the communications device with a plurality of HARQ-ACK, codebooks for transmitting HARQ-ACKs;
transmit a trigger to the communications device to transmit cancelled HARQ-ACKs, which could not be transmitted by the communications device in the scheduled uplink resources, in subsequently scheduled uplink resources, the communications device selecting one of the plurality of configured HARQ-ACK codebooks to transmit the cancelled HARQ-ACKs based on one or more conditions.

34.-37. (canceled)
